(19) United States
(12) Patent Application Publication
(10) Pub. No.: US 2017/0066969 A1
(43) Pub. Date: Mar. 9, 2017

(54) LIQUID CRYSTAL ALIGNMENT AGENT, LIQUID CRYSTAL ALIGNMENT FILM, AND LIQUID CRYSTAL DISPLAY ELEMENT

(71) Applicant: Chi Mei Corporation, Tainan City (TW)

(72) Inventor: Tsung-Pei Tsai, Tainan City (TW)

(73) Assignee: Chi Mei Corporation, Tainan City (TW)

(21) Appl. No.: 15/253,861

(22) Filed: Aug. 31, 2016

(30) Foreign Application Priority Data
Sep. 8, 2015 (TW) 104129706

(51) Int. Cl. C09K 19/56

(52) U.S. Cl. CPC C09K 19/56

(57) ABSTRACT

A liquid crystal alignment agent capable of forming a liquid crystal alignment film having good environmental resistance, the liquid crystal alignment film, and a liquid crystal display element having the liquid crystal alignment film are provided. The liquid crystal alignment agent includes a polymer (A), a benzotriazole compound (B) containing an epoxy group, and a solvent (C). The polymer (A) is obtained by reacting a mixture including a tetracarboxylic dianhydride component (a1) and a diamine component (a2).

### CROSS-REFERENCE TO RELATED APPLICATION

This application claims the priority benefit of Taiwan application serial no. 104129706, filed on Sep. 8, 2015. The entirety of the above-mentioned patent application is hereby incorporated by reference herein and made a part of this specification.

### BACKGROUND OF THE INVENTION

Field of the Invention

The invention relates to a liquid crystal alignment agent, a liquid crystal alignment film, and a liquid crystal display element, and more particularly, to a liquid crystal alignment agent that can be made into a liquid crystal display element having high environmental resistance, a liquid crystal alignment film formed thereby, and a liquid crystal display element having the liquid crystal alignment film.

Description of Related Art

In recent years, due to the gradual increase in the consumer demand for wide-viewing angle properties of the liquid crystal display, the demand for electrical properties or display properties of the wide-viewing angle liquid crystal display element is also becoming higher. Among various wide-viewing angle liquid crystal display elements, the vertical alignment liquid crystal display element having a liquid crystal alignment film is the most common, and to have better electrical properties and display properties, the liquid crystal alignment film has also become one of the important research targets for improving the properties of the vertical alignment liquid crystal display element.

The function of the liquid crystal alignment film in the vertical alignment liquid crystal display element is the regular arrangement of liquid crystal molecules and to allow the liquid crystal molecules to have greater tilt angle in the absence of an electric field. The forming method of the liquid crystal alignment film generally includes first coating a liquid crystal alignment agent containing a polymer material such as a polyamic acid polymer or a polyimide polymer on a substrate surface, and then performing a heat treatment and an alignment treatment to prepare the liquid crystal alignment film.

JP 2002-323701 discloses a vertical liquid crystal alignment agent containing polyamic acid and a crosslinking agent containing at least 2 reactive groups in the molecules, and the reactive groups can react with a carboxylic acid group of the polyamic acid. By using the liquid crystal alignment agent, a liquid crystal alignment film having good vertical alignment properties, high hardness, and good voltage holding ratio can be obtained. However, the liquid crystal alignment film has the drawback of poor environmental resistance. For instance, the issue of excessive ion density in a high-temperature and high-humidity environment readily occurs, which is unacceptable to the industry.

Therefore, to meet the demand of the current liquid crystal display industry, improving the environmental resistance of the liquid crystal alignment film is one of the important research objects for those skilled in the art.

### PATENT LITERATURE

[Patent literature 1] JP 2002-323701

### SUMMARY OF THE INVENTION

Accordingly, the invention provides a liquid crystal alignment agent for a liquid crystal display element. A liquid crystal alignment film obtained using the liquid crystal alignment agent can alleviate the issue of poor environmental resistance.

The invention provides a liquid crystal alignment agent, including: a polymer (A), a benzotriazole compound (B) containing an epoxy group, and a solvent (C). The polymer (A) is obtained by reacting a mixture. Specifically, the mixture includes a tetracarboxylic dianhydride component (a1) and a diamine component (a2).

In an embodiment of the invention, the epoxy group of the benzotriazole compound (B) containing an epoxy group is selected from at least one of the group consisting of functional groups represented by general formula (B-1) and general formula (B-2).

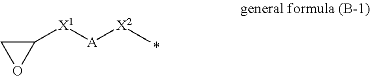

In general formula (B-1), A represents a single bond, an ether group, an ester group, or a urethane group; X¹ represents a C₁ to C₅ alkylene group; X² represents a single bond or a C₁ to C₆ alkylene group; and * represents a bonding site.

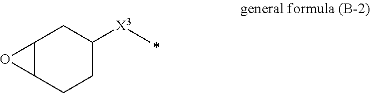

In general formula (B-2), X³ represents a single bond or a C₁ to C₆ alkylene group; and * represents a bonding site.

In an embodiment of the invention, the benzotriazole compound (B) containing an epoxy group contains at least one hydroxyl group.

In an embodiment of the invention, based on a total amount of 100 parts by weight of the polymer (A), the usage amount of the benzotriazole compound (B) containing an epoxy group is 1 part by weight to 15 parts by weight.

In an embodiment of the invention, the imidization ratio of the polymer (A) is 30% to 90%.

The invention further provides a liquid crystal alignment film. The liquid crystal alignment film is formed by the liquid crystal alignment agent above.

The invention further provides a liquid crystal display element. The liquid crystal display element includes the liquid crystal alignment film above.

Based on the above, since the liquid crystal alignment agent of the invention contains specific components (A) and (B), a liquid crystal alignment film having good vertical alignment properties, high hardness, and good voltage holding ratio can be obtained. Moreover, when the liquid crystal display element contains the liquid crystal alignment film formed by using the liquid crystal alignment agent of the invention, in addition to good vertical alignment properties, high hardness, and good voltage holding ratio, the issue of excessive ion density in a high-temperature and high-humidity environment can also be alleviated.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a side view of a liquid crystal display element according to an embodiment of the invention.

### DESCRIPTION OF THE EMBODIMENTS

### Liquid Crystal Alignment Agent

The invention provides a liquid crystal alignment agent, including: a polymer (A), a benzotriazole compound (B) containing an epoxy group, and a solvent (C). Moreover, the liquid crystal alignment agent can further include an additive (D) if needed.

In the following, each component of the liquid crystal alignment agent of the invention is described in detail.

It should be mentioned that, in the following, (meth)acrylic acid represents acrylic acid and/or methacrylic acid, and (meth)acrylate represents acrylate and/or methacrylate. Similarly, (meth)acryloyl group represents acryloyl group and/or methacryloyl group.

Polymer (A)

The polymer (A) is obtained by reacting a mixture. The mixture includes a tetracarboxylic dianhydride component (a1) and a diamine component (a2).

Specifically, the polymer (A) includes a polyamic acid, a polyimide, a polyamic acid-polyimide block copolymer, or a combination of the polymers. In particular, the polyimide-based block copolymer includes a polyamic acid block copolymer, a polyimide block copolymer, a polyamic acid-polyimide block copolymer, or a combination of the polymers. The polyamic acid polymer, the polyimide polymer, and the polyamic acid-polyimide block copolymer can all be obtained by reacting a mixture of the tetracarboxylic dianhydride component (a1) and the diamine component (a2).

Tetracarboxylic Dianhydride Component (a1)

The tetracarboxylic dianhydride component (a1) includes an aliphatic tetracarboxylic dianhydride compound, an alicyclic tetracarboxylic dianhydride compound, an aromatic tetracarboxylic dianhydride compound, at least one of the tetracarboxylic dianhydride compounds represented by formula (A1-1) to formula (A1-6), or a combination of the compounds.

Specific examples of the aliphatic tetracarboxylic dianhydride compound can include, but are not limited to, ethane tetracarboxylic dianhydride, butane tetracarboxylic dianhydride, or a combination of the compounds.

Specific examples of the alicyclic tetracarboxylic dianhydride compound can include, but are not limited to, 2,3,4-cyclobutane tetracarboxylic dianhydride, 1,2-dimethyl-1,2,3,4-cyclobutane tetracarboxylic dianhydride-3-dimethyl-1,2,3,4-cyclobutane tetracarboxylic dianhydride, 1,3-dichloro-1,2,3,4-cyclobutane tetracarboxylic dianhydride, 2,3,4-tetramethyl-1,2,3,4-cyclobutane tetracarboxylic dianhydride, 1,2,3,4-cyclopentane tetracarboxylic dianhydride, 1,2,4,5-cyclohexane tetracarboxylic dianhydride, 3,3′,4,4′-dicyclohexyl tetracarboxylic dianhydride, cis-3,7-dibutyl-cycloheptyl-1,5-diene-1,2,5,6-tetracarboxylic dianhydride, 2,3,5-tricarboxycyclopentylacetic dianhydride, bicyclo[2.2.2]-oct-7-ene-2,3,5,6-tetracarboxylic dianhydride, or a combination of the compounds.

Specific examples of the aromatic tetracarboxylic dianhydride compound can include, but are not limited to, an aromatic tetracarboxylic dianhydride compound such as 3,4-dicarboxy-1,2,3,4-tetrahydronaphthalene-1-succinic dianhydride, pyromellitic dianhydride, 3,3′,4,4′-benzophenone tetracarboxylic dianhydride, 3′,3,4,4′-biphenylsulfone tetracarboxylic dianhydride, 4,5,8-naphthalene tetracarboxylic dianhydride, 2,3,6,7-naphthalene tetracarboxylic dianhydride, 3,3′4,4′-diphenyl ethane tetracarboxylic dianhydride, 3,3′,-4,4′-dimethyl diphenyl silane tetracarboxylic dianhydride, 3,3′,4,4′-tetraphenyl silane tetracarboxylic dianhydride, 2,3,4-furan tetracarboxylic dianhydride, 4,4′-bis(3,4-dicarboxy phenoxy)diphenylsulfide dianhydride, 4,4′-bis(3,4-dicarboxy phenoxy)diphenylsulfone dianhydride, 4,4′-bis(3,4-dicarboxy phenoxy)diphenylpropane dianhydride, 3,3′,4,4′-perfluoroisopropylidene diphenyl dicarboxylic dianhydride, 3,3′,4,4′-diphenyl tetracarboxylic dianhydride, bis(phthalic acid)phenylphosphine oxide dianhydride, p-phenylene-bis(triphenylphthalic acid)dianhydride, m-phenylene-bis(triphenylphthalic acid)dianhydride, bis(triphenylphthalic acid)-4,4′-diphenylether dianhydride, bis(triphenylphthalic acid)-4,4′-diphenylmethane dianhydride, ethylene glycol-bis(anhydrotrimellitate), propylene glycol-bis(anhydrotrimellitate), 1,4-butanediol-bis(anhydrotrimellitate), 1,6-hexanediol-bis(anhydrotrimellitate), 1, 8-octanediol-bis(anhydrotrimellitate), 2,2-bis(4-hydroxyphenyl)propane-bis(anhydrotrimellitate), 2,3,4,5-tetrahydrofuran tetracarboxylic dianhydride, 3,3a,4,5,9b-hexahydro-5-(tetrahydro-2,5-dioxo-3-furanyl)naphtho[1,2-c]furan-1,3-dione, 3,3a,4,5,9b-hexahydro-5-methyl-5-(tetrahydro-2,5-dioxo-3-furanyl)naphtho[1,2-c]furan-1,3-dione, 1,3,3a,4,5,9b-hexahydro-5-ethyl-5-(tetrahydro-2,5-dioxo-3-furanyl)naphtho[1,2-c]furan-1,3-dione, 1,3,3a,4,5,9b-hexahydro-7-methyl-5-(tetrahydro-2,5-dioxo-3-furanyl) naphtho[1,2-c]furan-1,3-dione, 1,3,3a,4,5,9b-hexahydro-7-ethyl-5-(tetrahydro-2,5-dioxo-3-furanyl)naphtho[1,2-c]furan-1,3-dione-3,3a,4,5,9b-hexahydro-8-methyl-5-(tetrahydro-2,5-dioxo-3-furanyl)naphtho[1,2-c]furan-1,3-dione, 3,3a,4,5,9b-hexahydro-8-ethyl-5-(tetrahydro-2, 5-dioxo-3-furanyl)naphtho[1,2-c]furan-1,3-dione, 1,3,3a,4,5,9b-hexahydro-5,8-dimethyl-5-(tetrahydro-2,5-dioxo-3-furanyl)naphtho[1,2-c]furan-1,3-dione, 5-(2,5-dioxotetrahydrofural)-3-methyl-3-cyclohexene-1,2-dicarboxylic dianhydride, or a combination of the compounds.

The tetracarboxylic dianhydride compounds represented by formula (A1-1) to formula (A1-6) are as shown below.

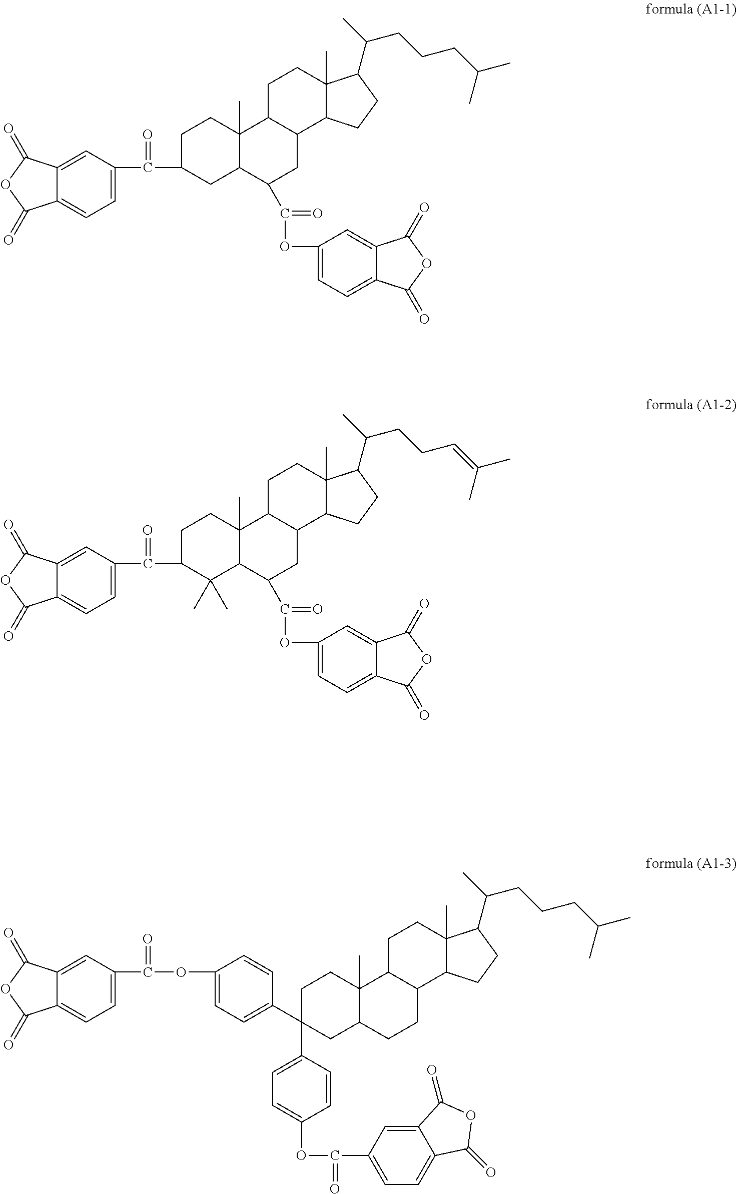

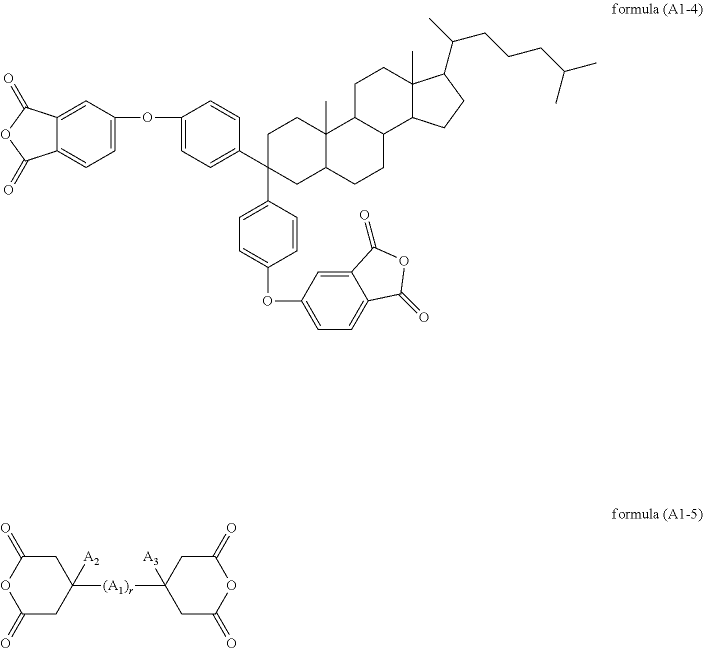

In formula (A1-5), A¹ represents a divalent group containing an aromatic ring; r represents an integer of 1 to 2; and A² and A³ can be the same or different, and can each independently represent a hydrogen atom or an alkyl group. Specific examples of the tetracarboxylic dianhydride compound represented by formula (A1-5) include at least one of the compounds represented by formula (A1-5-1) to formula (A1-5-3).

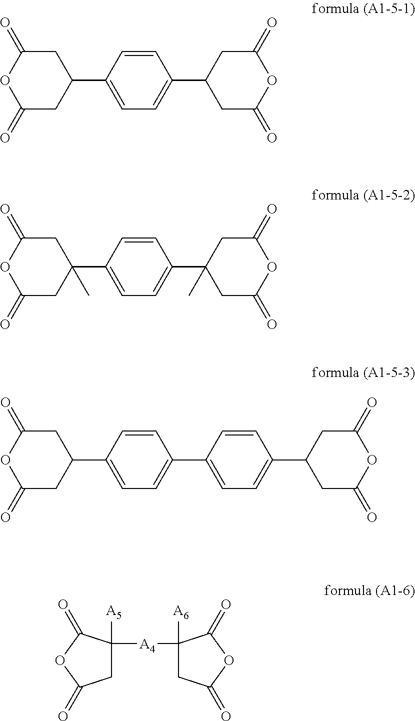

In formula (A1-6), A⁴ represents a divalent group containing an aromatic ring; A⁵ and A⁶ can be the same or different, and each independently represent a hydrogen atom or an alkyl group. The tetracarboxylic dianhydride compound represented by formula (A1-6) is preferably a compound represented by formula (A1-6-1).

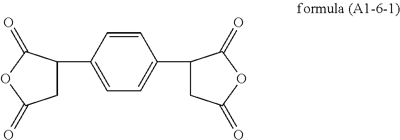 [SMILES: O=C1CC(c2ccc(C3CC(=O)OC3=O)cc2)C(=O)O1]

The tetracarboxylic dianhydride component (a) can be used alone or in multiple combinations.

Diamine Component (a2)

The diamine component (a2) includes an aliphatic diamine compound, an alicyclic diamine compound, an aromatic diamine compound, diamine compounds having formula (A2-1) to formula (A2-30), or a combination thereof.

Specific examples of the aliphatic diamine compound include, but are not limited to, 1,2-diaminoethane, 1,3-diaminopropane, 1,4-diaminobutane, 1,5-diaminopentane, 1, 6-diaminohexane, 1,7-diaminoheptane, 1,8-diaminooctane, 1,9-diaminononane, 1,10-diaminodecane, 4,4′-diaminoheptane, 1,3-diamino-2,2-dimethylpropane, 1,6-diamino-2,5-dimethylhexane, 1,7-diamino-2,5-dimethylheptane, 1,7-diamino-4,4-dimethylheptane, 1,7-diamino-3-methylheptane, 1,9-diamino-5-methylnonane, 2,11-diaminododecane, 1,12-diaminooctadecane, 1,2-bis(3-anopropoxy)ethane, or a combination of the compounds.

Specific examples of the alicyclic diamine compound include, but are not limited to, 4,4′-diaminodicyclohexylmethane, 4,4′-diamino-3,3′-dimethyl dicyclohexylamine, 1,3-diaminocyclohexane, 1,4-diaminocyclohexane, isophorone diamine, tetrahydrodicyclopentadiene diamine, tricyclo[6.2.1.0^{2,7}]-undecenedimethyl diamine, 4,4′-methylene bis(cyclohexylamine), or a combination of the compounds.

Specific examples of the aromatic diamine compound include, but are not limited to, 4,4′-diaminodiphenylmethane, 4,4′-diaminodiphenylethane, 4,4′-diaminodiphenylsulfone, 4,4′-diaminobenzoylaniline, 4,4′-diaminodiphenylether, 3,4′-diaminodiphenylether, 1,5-diaminonaphthalene, 5-amino-1-(4′-aminophenyl)-1,3,3-trimethylindene, 6-amino-1-(4′-aminophenyl)-1,3,3-trimethylindene, hexahydro-4,7-methanoindanylenedimethylenediamine, 3,3′-diaminobenzophenone, 3,4′-diamino benzophenone, 4,4′-diaminobenzophenone, 2,2-bis[4-(4-aminophenoxy)phenyl]propane, 2,2-bis[4-(4-aminophenoxy)phenyl]hexafluoropropane, 2,2-bis(4-aminophenyl) hexafluoropropane, 2,2-bis[4-(4-aminophenoxy)phenyl]sulfone, 1,4-bis(4-aminophenoxy)benzene, 1,3-bis(4-aminophenoxy)benzene, 1,3-bis(3-aminophenoxy)benzene, 9,9-bis(4-aminophenyl)-10-hydroanthracene, 9,10-bis(4-aminophenyl) anthracene, 2,7-diaminofluorene, 9,9-bis(4-aminophenyl)fluorene, 4,4′-methylene-bis(2-chloroaniline), 4,4′-(p-phenyleneisopropylidene)bisaniline, 4,4′-(m-phenylene isopropylidene)bisaniline, 2,2′-bis[4-(4-amino-2-trifluoromethylphenoxy)phenyl]hexafluoropropane, 4,4′-bis[(4-amino-2-trifluoromethyl)phenoxy]-octafluorobiphenyl, 5-[4-(4-n-pentylcyclohexyl)cyclohexyl]phenylmethylene-1,3-diaminobenzene, 1, 1-bis[4-(4-aminophenoxy)phenyl]-4-(4-ethylphenyl)cyclohexane, or a combination of the compounds.

The diamine compounds having formula (A2-1) to formula (A2-30) are as shown below.

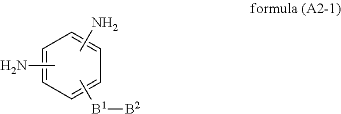

In formula (A2-1), B¹ represents

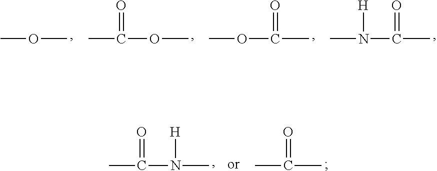

and B² represents a group having a steroid skeleton, a trifluoromethyl group, a fluorine group, a C₂ to C₃₀ alkyl group, or a monovalent group of a cyclic structure containing a nitrogen atom derived from, for instance, pyridine, pyrimidine, triazine, piperidine, or piperazine.

Specific examples of the compound represented by formula (A2-1) include, but are not limited to, 2,4-diaminophenyl ethyl formate, 3,5-diaminophenyl ethyl formate, 2,4-diaminophenyl propyl formate, 3,5-diaminophenyl propyl formate, 1-dodecoxy-2,4-diaminobenzene, 1-hexadecoxy-2,4-diaminobenzene, 1-octadecoxy-2,4-diaminobenzene, at least one of the compounds represented by formula (A2-1-1) to formula (A2-1-6), or a combination of the compounds.

The compounds represented by formula (A2-1-1) to formula (A2-1-6) are as shown below.

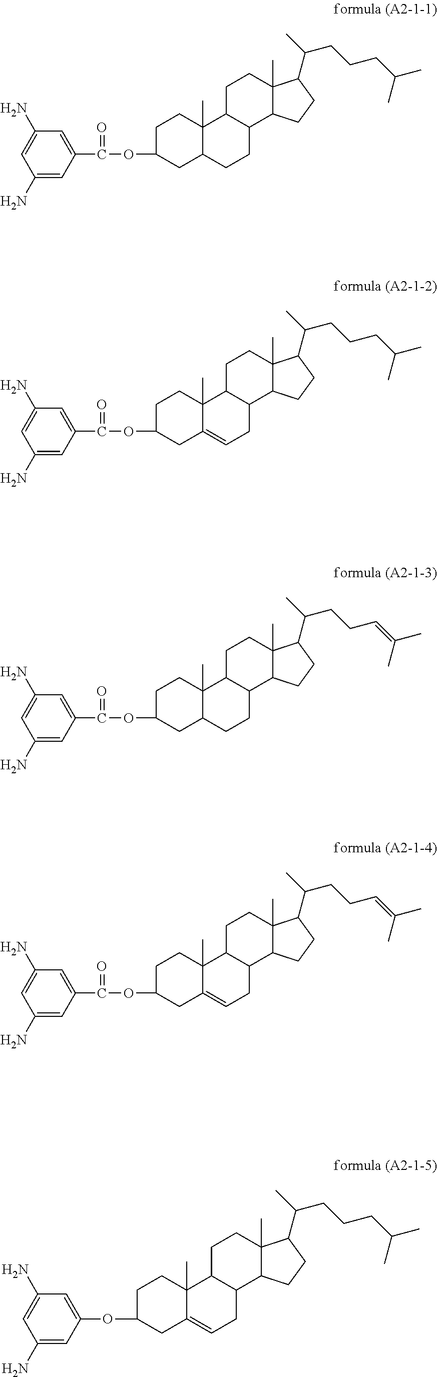

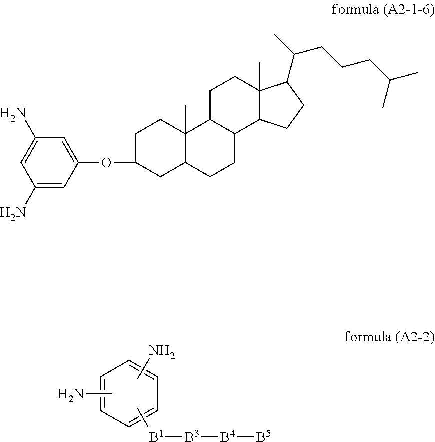

In formula (A2-2), B¹ is the same as the B¹ in formula (A2-1), B³ and B⁴ each independently represent a divalent aliphatic ring, a divalent aromatic ring, or a divalent heterocyclic group; B⁵ represents a C₃ to C₁₈ alkyl group, a C₃ to C₁₈ alkoxy group, a C₁ to C₅ fluoroalkyl group, a C₁ to C₅ fluoroalkyloxy group, a cyano group, or a halogen atom.

Specific examples of the compound represented by formula (A2-2) include at least one of the compounds represented by formula (A2-2-1) to formula (A2-2-13). Specifically, the compounds represented by formula (A2-2-1) to formula (A2-2-13) are as follows.

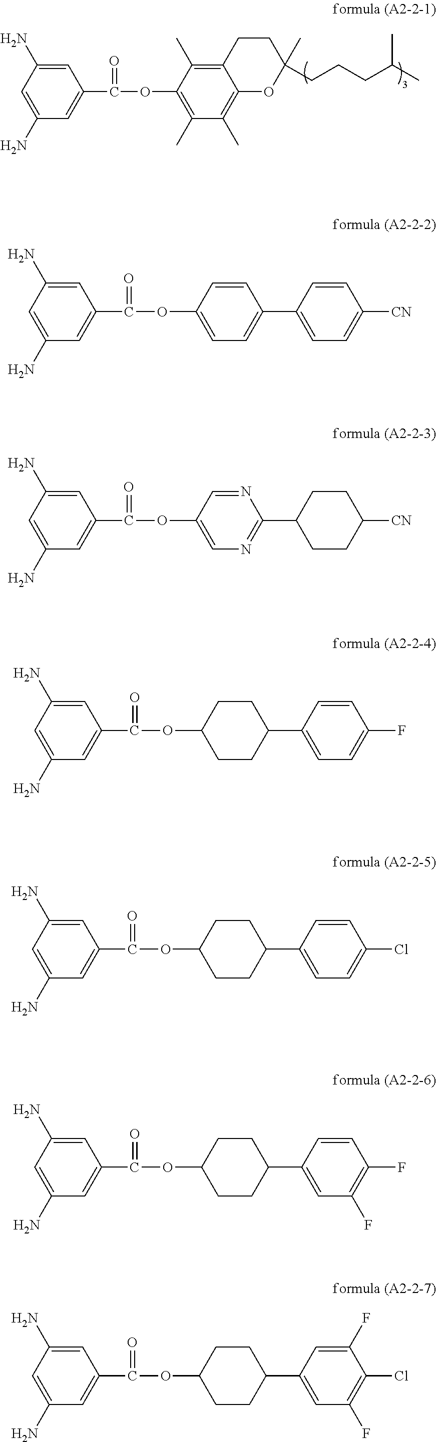

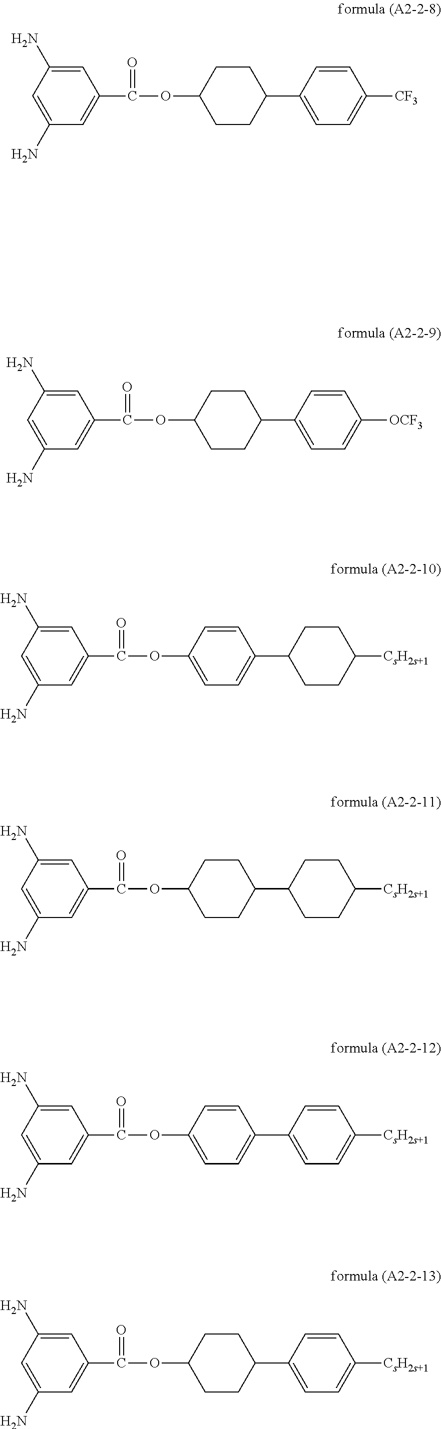

In formula (A2-2-10) to formula (A2-2-13), s represents an integer of 3 to 12.

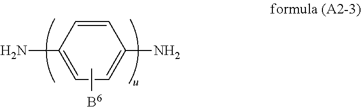

In formula (A2-3), B⁶ each independently represents a hydrogen atom, a C₁ to C₅ acyl group, a C₁ to C₅ alkyl group, a C₁ to C₅ alkoxy group, or a halogen atom, and B⁶ in each repeating unit can be the same or different; and u represents an integer of 1 to 3.

Specific examples of the compound represented by formula (A2-3) include: when u is 1: p-diaminobenzene, m-diaminobenzene, o-diaminobenzene, or 2,5-diaminotoluene . . . etc.; when u is 2: 4,4′-diaminobiphenyl, 2,2′-dimethyl-4,4′-diaminobiphenyl, 3,3′-dimethyl-4,4′-diaminobiphenyl, 3,3′-dimethoxy-4,4′-diaminobiphenyl, 2,2′-dichloro-4,4′-diaminobiphenyl, 3,3′-dichloro-4,4′-diaminobiphenyl, 2,2′,5,5′-tetrachloro-4,4′-diaminobiphenyl, 2,2′-dichloro-4,4′-diamino-5,5′-dimethoxybiphenyl, or 4,4′-diamino-2,2′-bis(trifluoromethyl) biphenyl . . . etc.; or when u is 3: 1,4-bis(4′-aminophenyl)benzene . . . etc.

Specific examples of the compound represented by formula (A2-3) preferably include p-diaminobenzene, 2,5-diaminotoluene, 4,4′-diaminobiphenyl, 3,3′-dimethoxy-4,4′-diaminobiphenyl, 1,4-bis(4′-aminophenyl)benzene, or a combination of the compounds.

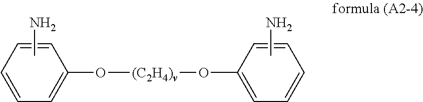

In formula (A2-4), v represents an integer of 2 to 12.

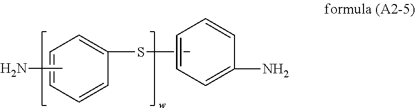

In formula (A2-5), w represents an integer of 1 to 5. The compound represented by formula (A2-5) is preferably 4,4′-diamino-diphenyl sulfide.

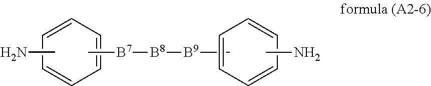

In formula (A2-6), B⁷ and B⁹ each independently represent a divalent organic group, and B⁷ and B⁹ can be the same or different; B⁸ represents a divalent group of a cyclic structure containing a nitrogen atom derived from, for instance, pyridine, pyrimidine, triazine, piperidine, or piperazine.

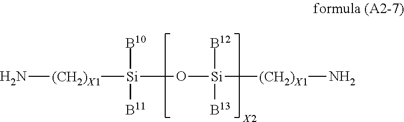

In formula (A2-7), B¹⁰, B¹¹, B¹², and B¹³ each independently represent a C₁ to C₁₂ hydrocarbon group, and B¹⁰, B¹¹, B¹², and B¹³ can be the same or different; X1 each independently represents an integer of 1 to 3; and X2 represents an integer of 1 to 20.

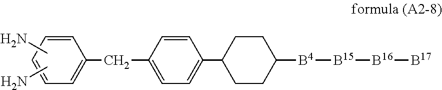

In formula (A2-8), B¹⁴ represents an oxygen atom or a cyclohexylene group; B¹⁵ represents a methylene group (—CH₂); B¹⁶ represents a phenylene group or a cyclohexylene group; and B¹⁷ represents a hydrogen atom or a heptyl group.

Specific examples of the compound represented by formula (A2-8) include a compound represented by formula (A2-8-1), a compound represented by formula (A2-8-2), or a combination of the compounds.

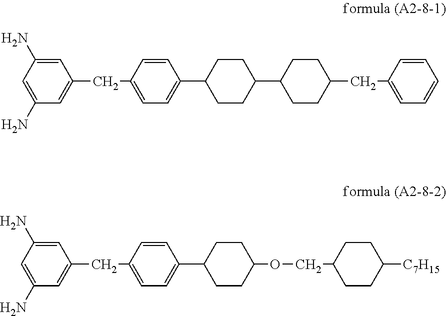

The compounds represented by formula (A2-9) to formula (A2-30) are as shown below.

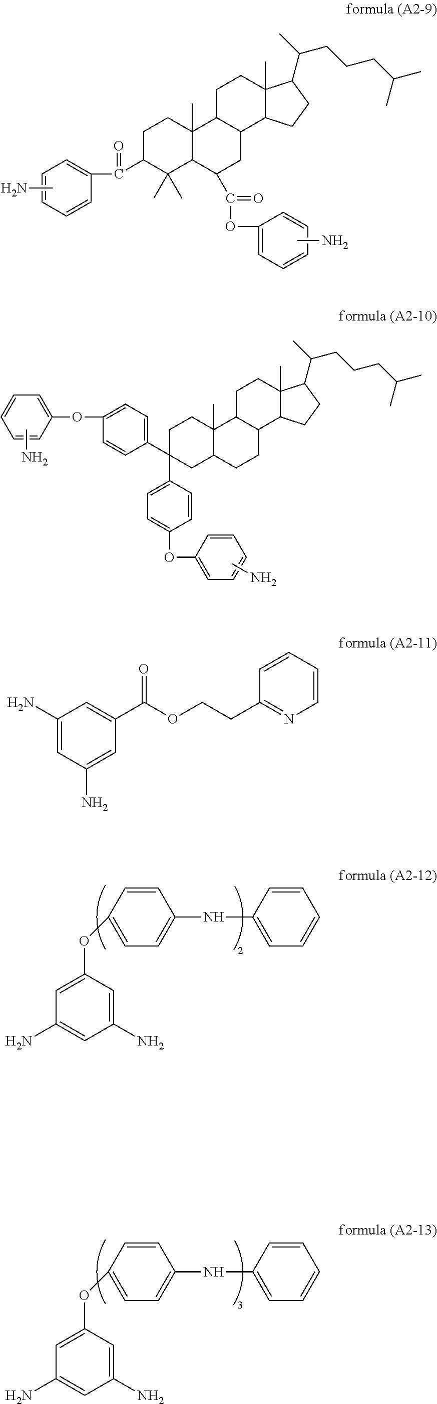

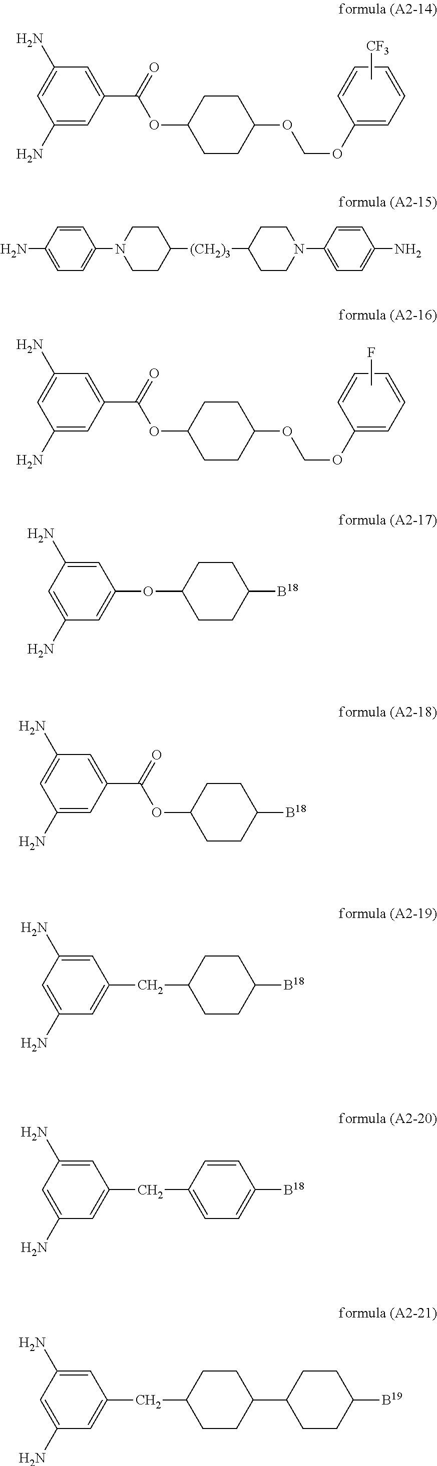

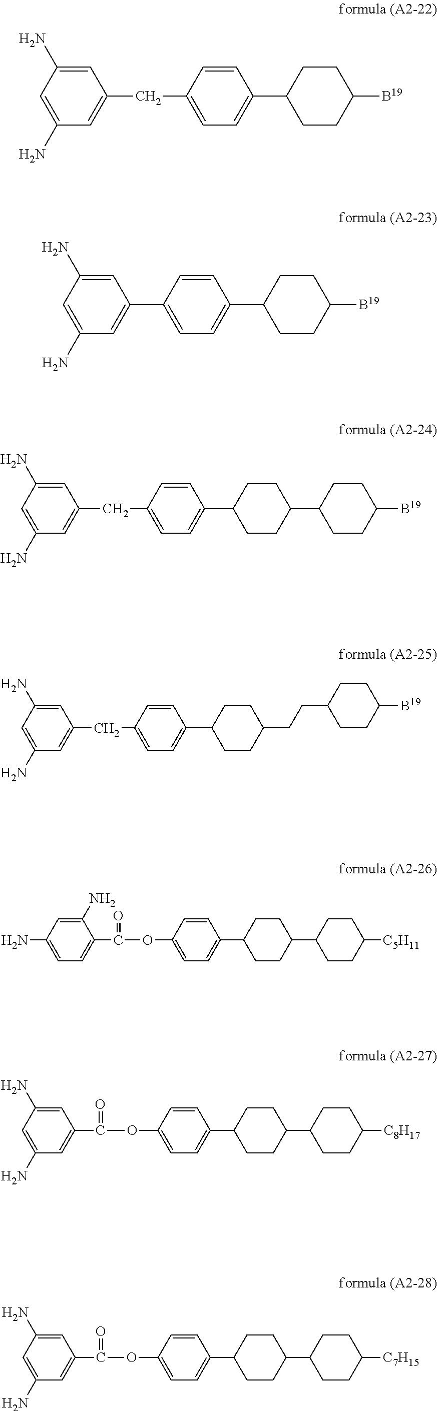

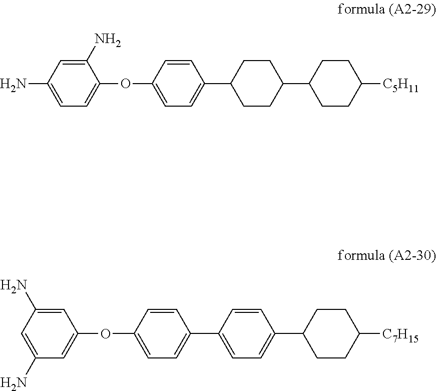

In formula (A2-17) to formula (A2-25), B¹⁸ preferably represents a C₁ to C₁₀ alkyl group or a C₁ to C₁₀ alkoxy group; B¹⁹ preferably represents a hydrogen atom, a C₁ to C₁₀ alkyl group, or a C₁ to C₁₀ alkoxy group.

The diamine component (a2) can be used alone or in multiple combinations.

Specific examples of the diamine component (a2) preferably include, but are not limited to, 1,2-diaminoethane, 4,4′-diaminodicyclohexylmethane, 4,4′-diaminodiphenylmethane, 4,4′-diaminodiphenyl ether, 5-[4-(4-n-pentylcyclohexyl) cyclohexyl]phenylmethylene-1,3-diaminobenzene, 1,1-bis[4-(4-aminophenoxy)phenyl]-4-(4-ethylphenyl)cyclohexane, 2,4-diaminophenyl ethyl formate, 1-octadecoxy-2,4-diaminobenzene, a compound represented by formula (A2-1-1), a compound represented by formula (A2-1-2), a compound represented by formula (A2-1-4), a compound represented by formula (A2-1-5), a compound represented by formula (A2-2-1), a compound represented by formula (A2-2-11), p-diaminobenzene, m-diaminobenzene, o-diaminobenzene, a compound represented by formula (A2-8-1), compounds represented by formula (A2-26) to formula (A2-30), or a combination of the compounds.

When the polymer (A) in the liquid crystal alignment agent contains at least one of the diamine compounds (a2) represented by formula (A2-1), formula (A2-2), and formula (A2-26) to formula (A2-30), the environmental resistance of the liquid crystal display element can be further increased.

Method of Preparing Polymer (A)

The polymer (A) can include at least one of polyamic acid and polyimide. Moreover, the polymer (A) can further include a polyimide-based block copolymer. The preparation method of each of the various polymers above is further described below.

Method of Preparing Polyamic Acid

The method of preparing the polyamic acid includes first dissolving a mixture in a solvent, wherein the mixture includes the tetracarboxylic dianhydride component (a1) and the diamine component (a2). A polycondensation reaction is then performed at a temperature of 0° C. to 100° C. After reacting for 1 hour to 24 hours, the reaction solution is distilled under reduced pressure with an evaporator to obtain the polyamic acid. Alternatively, the reaction solution is poured into a large amount of a poor solvent to obtain a precipitate. Then, the precipitate is dried with a method of drying under reduced pressure to obtain the polyamic acid.

Based on a total number of moles of 100 moles of the diamine component (a2), the usage amount of the tetracarboxylic dianhydride component (a1) is 20 moles to 200 moles; preferably, the usage amount of the tetracarboxylic dianhydride component (a1) is 30 moles to 120 moles.

The solvent used in the polycondensation reaction can be the same or different as the solvent in the liquid crystal alignment agent below, and the solvent used in the polycondensation reaction is not particularly limited, provided the solvent can dissolve the reactants and the products. The solvent preferably includes, but is not limited to (1) an aprotic polar solvent such as N-methyl-2-pyrrolidinone (NMP), N,N-dimethyl acetamide, N,N-dimethyl formamide, dimethyl sulfoxide, γ-butyrolactone, tetramethylurea, or hexamethylphosphoramide; or (2) a phenolic solvent such as m-cresol, xylenol, phenol, or halogenated phenol. Based on a total usage amount of 100 parts by weight of the mixture, the usage amount of the solvent used in the polycondensation reaction is preferably 200 parts by weight to 2000 parts by weight, more preferably 300 parts by weight to 1800 parts by weight.

It should be mentioned that, in the polycondensation reaction, the solvent can be used with a suitable amount of a poor solvent, wherein the poor solvent does not cause precipitation of the polyamic acid. The poor solvent can be used alone or in multiple combinations, and includes, but is not limited to (1) an alcohol such as methanol, ethanol, isopropanol, cyclohexanol, ethylene glycol, propylene glycol, 1,4-butanediol, or triglycol; (2) a ketone such as acetone, methyl ethyl ketone, methyl isobutyl ketone, or cyclohexanone; (3) an ester such as methyl acetate, ethyl acetate, butyl acetate, diethyl oxalate, diethyl malonate, or ethylene glycol monoethyl ether acetate; (4) an ether such as diethyl ether, ethylene glycol monomethyl ether, ethylene glycol monoethyl ether, ethylene glycol n-propyl ether, ethylene glycol isopropyl ether, ethylene glycol n-butyl ether, ethylene glycol dimethyl ether, or diethylene glycol dimethyl ether; (5) a halogenated hydrocarbon such as dichloromethane, 1,2-dichloroethane, 1,4-dichlorobutane, trichloroethane, chlorobenzene, or o-dichlorobenzene; or (6) a hydrocarbon such as tetrahydrofuran, hexane, heptane, octane, benzene, toluene, or xylene, or any combination of the solvents. Based on a usage amount of 100 parts by weight of the dial e component (a2), the usage amount of the poor solvent is preferably 0 parts by weight to 60 parts by weight, more preferably 0 parts by weight to 50 parts by weight.

Method of Preparing Polyimide

The method of preparing the polyimide includes heating the polyamic acid obtained by the above method of preparing polyamic acid under the existence of a dehydrating agent and a catalyst. During the heating process, the amic acid functional group in the polyamic acid can be converted into an imide functional group through a cyclodehydration reaction (i.e., imidization).

The solvent used in the cyclodehydration reaction can be the same as the solvent (C) in the liquid crystal alignment agent and is therefore not repeated herein. Based on a usage amount of 100 parts by weight of the polyamic acid, the usage amount of the solvent used in the cyclodehydration reaction is preferably 200 parts by weight to 2000 parts by weight, more preferably 300 parts by weight to 1800 parts by weight.

To obtain a preferable degree of imidization of the polyamic acid, the operating temperature of the cyclodehydration reaction is preferably 40° C. to 200° C., more preferably 40° C. to 150° C. If the operating temperature of the cyclodehydration reaction is less than 40° C., then the imidization reaction is incomplete, and the degree of imidization of the polyamic acid is thereby reduced. However, if the operating temperature of the cyclodehydration reaction is higher than 200° C., then the weight-average molecular weight of the obtained polyimide is lower.

The dehydrating agent used in the cyclodehydration reaction can be selected from an anhydride compound, and specific examples thereof include, for instance, acetic anhydride, propionic anhydride, or trifluoroacetic anhydride. Based on 1 mole of the polyamic acid, the usage amount of the dehydrating agent is 0.01 moles to 20 moles. The catalyst used in the cyclodehydration reaction can be selected from (1) a pyridine compound such as pyridine, trimethyl pyridine, or dimethyl pyridine; or (2) a tertiary amine compound such as triethylamine. Based on a usage amount of 1 mole of the dehydrating agent, the usage amount of the catalyst can be 0.5 moles to 10 moles.

The imidization ratio of the polymer (A) can be 30% to 90%, preferably 35% to 85%, and more preferably 40% to 80%. When the imidization ratio of the polymer (A) in the liquid crystal alignment agent is within the above ranges, the environmental resistance of the formed liquid crystal alignment film can further be improved.

Method of Preparing Polyimide-Based Block Copolymer

The polyimide-based block copolymer is selected from a polyamic acid block copolymer, a polyimide block copolymer, a polyamic acid-polyimide block copolymer, or any combination of the polymers.

The method of preparing the polyimide-based block copolymer preferably includes first dissolving a initiator in a solvent and then performing a polycondensation reaction, wherein the initiator includes at least one type of polyamic acid and/or at least one type of polyimide, and can further include a carboxylic anhydride component and a diamine component.

The carboxylic anhydride component and the diamine component in the initiator can be the same as the tetracarboxylic dianhydride component (a1) and the diamine component (a2) used in the method of preparing the polyamic acid. Moreover, the solvent used in the polycondensation reaction can be the same as the solvent (C) in the liquid crystal alignment agent below and is not repeated herein.

Based on a usage amount of 100 parts by weight of the initiator, the usage amount of the solvent used in the polycondensation reaction is preferably 200 parts by weight to 2000 parts by weight, more preferably 300 parts by weight to 1800 parts by weight. The operating temperature of the polycondensation reaction is preferably 0° C. to 200° C., more preferably 0° C. to 100° C.

The initiator preferably includes, but is not limited to (1) two polyamic acids for which the terminal groups are different and the structures are different; (2) two polyimides for which the terminal groups are different and the structures are different; (3) a polyamic acid and a polyimide for which the terminal groups are different and the structures are different; (4) a polyamic acid, a carboxylic anhydride component, and a diamine component, wherein the structure of at least one of the carboxylic anhydride component and the diamine component is different from the structures of the carboxylic anhydride component and the diamine component used to form the polyamic acid; (5) a polyimide, a carboxylic anhydride component, and a diamine component, wherein the structure of at least one of the carboxylic anhydride component and the diamine component is different from the structures of the carboxylic anhydride component and the diamine component used to form the polyimide; (6) a polyamic acid, a polyimide, a carboxylic anhydride component, and a diamine component, wherein the structure of at least one of the carboxylic anhydride component and the diamine component is different from the structures of the carboxylic anhydride component and the diamine component used to form the polyamic acid or the polyimide; (7) two polyamic acids having different structures, a carboxylic anhydride component, and a diamine component; (8) two polyimides having different structures, a carboxylic anhydride component, and a diamine component; (9) two polyamic acids having anhydride groups as terminal groups and having different structures, and a diamine component; (10) two polyamic acids having amine groups as terminal groups and having different structures, and a carboxylic anhydride component; (11) two polyimides having anhydride groups as terminal groups and having different structures, and a diamine component; or (12) two polyimides having amine groups as terminal groups and having different structures, and a carboxylic anhydride component.

Without affecting the efficacy of the invention, the polyamic acid, the polyimide, and the polyimide-based block copolymer are preferably terminal-modified polymers in which molecular weight regulation is first performed. By using the terminal-modified polymers, the coating performance of the liquid crystal alignment agent can be improved. The method of preparing the terminal-modified polymers can include adding a monofunctional compound at the same time a polycondensation reaction is performed on the polyamic acid.

Specific examples of the monofunctional compound include, but are not limited to, (1) a monoanhydride such as maleic anhydride, phthalic anhydride, itaconic anhydride, n-decyl succinic anhydride, n-dodecyl succinic anhydride, n-tetradecyl succinic anhydride, or n-hexadecyl succinic anhydride; (2) a monoamine compound such as aniline, cyclohexylamine, n-butylamine, n-amylamine, n-hexylamine, n-heptylamine, n-octylamine, n-nonylamine, n-decylamine, n-undecylamine, n-dodecylamine, n-tridecylamine, n-tetradecylamine, n-pentadecylamine, n-hexadecylamine, n-heptadecylamine, n-octadecylamine, or n-eicosylamine; or (3) a monoisocyanate compound such as phenyl isocyanate or naphthyl isocyanate.

In the polymer (A) of the invention, the polystyrene-equivalent weight average molecular weight obtained according to gel permeation chromatography (GPC) is 2,000 to 200,000, preferably 3,000 to 100,000, and more preferably 4,000 to 50,000.

Benzotriazole Compound (B) Containing an Epoxy Group

The epoxy group in the benzotriazole compound (B) containing an epoxy group is selected from at least one of the group consisting of functional groups represented by general formula (B-1) and general formula (B-2).

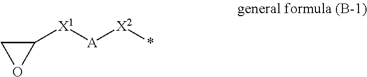

In general formula (B-1), A represents a single bond, an ether group, an ester group, or a urethane group; X¹ represents a C₁ to C₅ alkylene group; X² represents a single bond or a C₁ to C₆ alkylene group; and * represents a bonding site.

Specifically, in general formula (B-1), preferably, A represents an ether group, an ester group, or a urethane group; X¹ represents a C₁ to C₃ alkylene group; X² represents a single bond or a C₁ to C₄ alkylene group. More preferably, A represents an ether group or an ester group; X¹ represents a C₁ to C₃ alkylene group; X² represents a single bond or a C₁ to C₃ alkylene group.

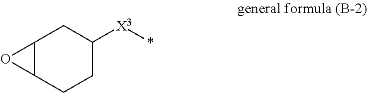

In general formula (B-2), X³ represents a single bond or a C₁ to C₆ alkylene group; and * represents a bonding site.

Specifically, in general formula (B-2), preferably, X³ represents a single bond or a C₁ to C₄ alkylene group. More preferably, X³ represents a single bond or a C₁ to C₃ alkylene group.

Specific examples of the functional group represented by general formula (B-1) or general formula (B-2) include at least one of the following functional groups, but are not limited to the specific examples.

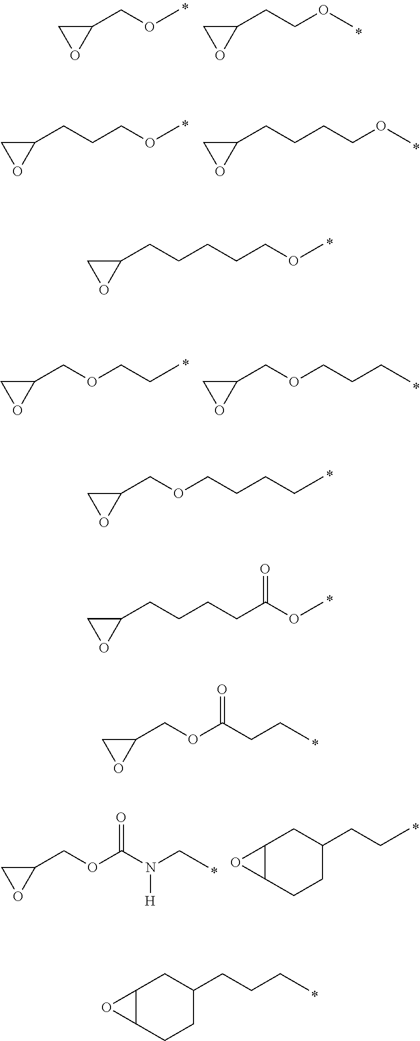

More specifically, the benzotriazole compound (B) containing an epoxy group preferably has a structure represented by general formula (B-3) to (B-4),

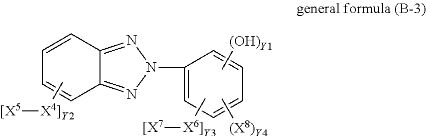

In general formula (B-3), X⁴ and X⁶ respectively independently represent a single bond, a C₁ to C₆ ester group, a C₁ to C₁₅ ether group or a C₁ to C₂₀ urethane group wherein a portion of the carbon atoms are substituted by silicon atoms or are not substituted; X⁵ and X⁷ respectively independently represent a group of a functional group represented by general formula (B-1) or general formula (B-2); X⁸ represents a C₁ to C₅ hydrocarbon group, a C₁ to C₁₀ ester group, or a C₁ to C₁₅ urethane group; Y1 represents an integer of 0 to 3; Y2 represents an integer of 0 to 2, Y3 represents an integer of 0 to 2, and Y4 represents an integer of 0 to 2, but Y2 and Y3 cannot be 0 at the same time.

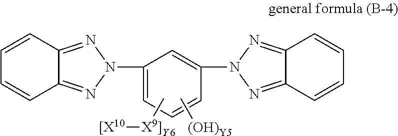

In general formula (B-4), X⁹ represents a single bond, a C₁ to C₆ ester group, a C₁ to C₁₅ ether group or a C₁ to C₂₀ urethane group wherein a portion of carbon atoms are substituted by silicon atoms or are not substituted; X¹⁰ represents a group of a functional group represented by general formula (B-1) or general formula (B-2); Y5 represents an integer of 0 to 2; and Y6 represents an integer of 1 to 2.

Specific examples of the benzotriazole compound (B) containing an epoxy group represented by general formulas (B-3) and (B-4) are, for instance, compounds represented by formulas (B-3-1) to (B-3-12) and formulas (B-4-1) and (B-4-2), but are not limited to these specific examples.

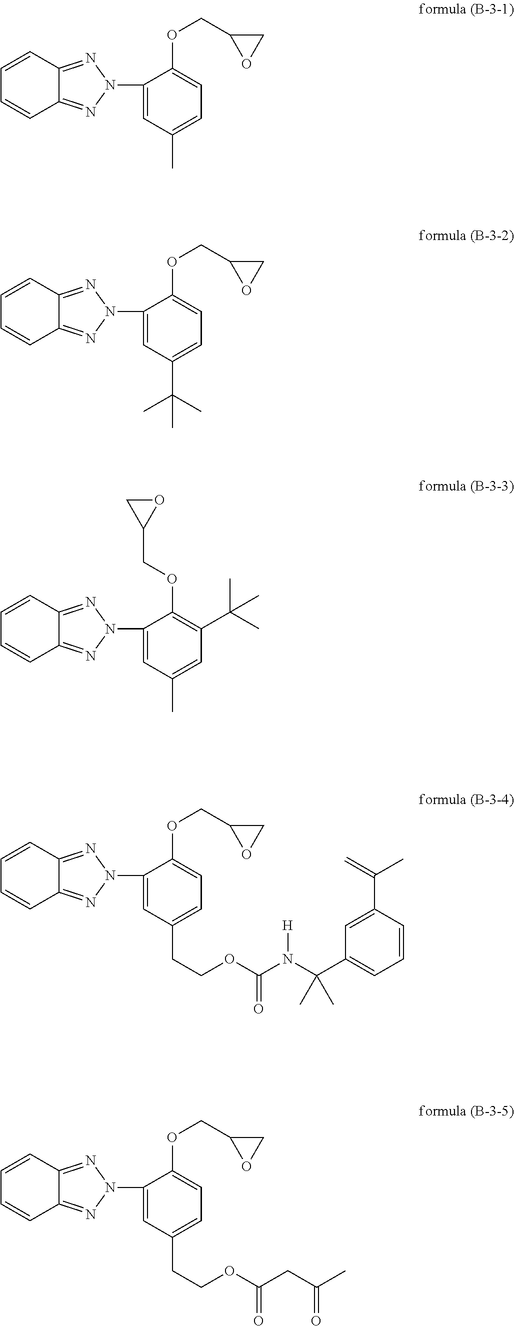

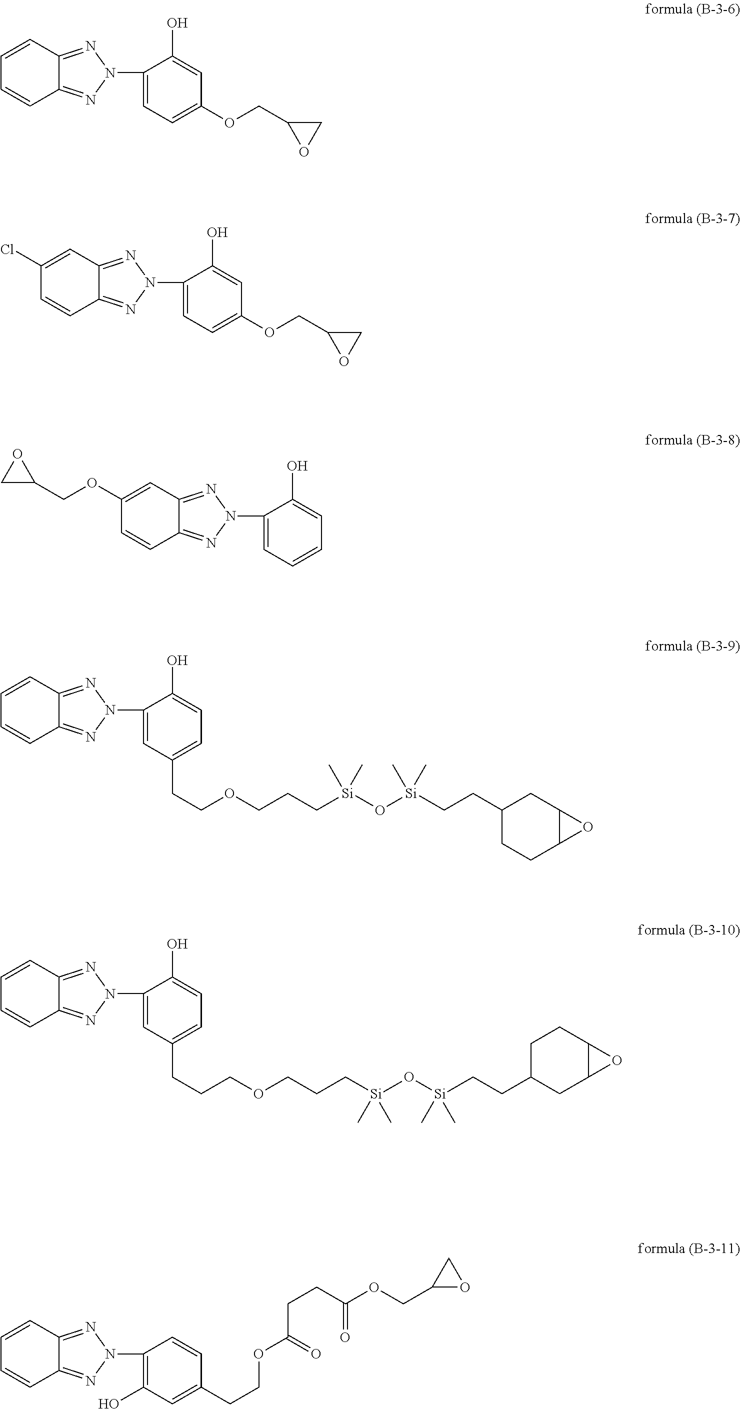

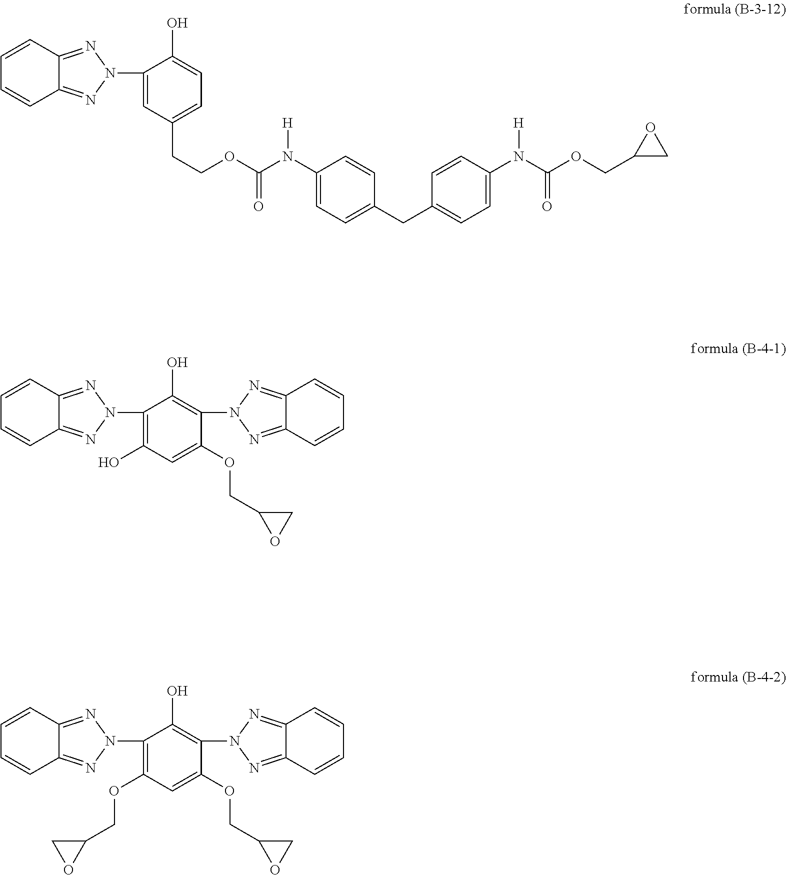

Based on a total amount of 100 parts by weight of the polymer (A), the usage amount of the benzotriazole compound (B) containing an epoxy group can be 1 part by weight to 15 parts by weight, preferably 2 parts by weight to 12 parts by weight, and more preferably 3 parts by weight to 10 parts by weight.

When the liquid crystal alignment agent does not contain the benzotriazole compound (B) containing an epoxy group, the environmental resistance of the liquid crystal display element is poor. When the benzotriazole compound (B) containing an epoxy group contains at least one hydroxyl group, the environmental resistance of the liquid crystal display element can be further increased.

Method of Preparing Benzotriazole Compound (B) Containing an Epoxy Group

The method of preparing the benzotriazole compound (B) containing an epoxy group is not particularly limited, and a general organic synthesis method can be used for the preparation of the benzotriazole compound (B) containing an epoxy group of the invention, such as: (i) reacting a benzotriazole derivative containing a hydroxyl group with a haloalkane compound containing an epoxy group in a nitrogen environment in the presence of alkali (such as potassium carbonate); (ii) reacting a benzotriazole derivative containing a hydroxyl group with an isocyanate compound containing an epoxy group in a nitrogen environment in the presence of a catalyst (such as dibutyltin dilaurate); (iii) reacting a benzotriazole derivative containing a hydroxyl group with a carboxylic acid compound containing an epoxy group in a nitrogen environment in the presence of a catalyst (such as sulfuric acid); or (iv) performing a hydrosilylation reaction on a benzotriazole derivative containing a vinyl group and a siloxane compound containing an epoxy group using a Karstedt's catalyst.

Specific examples of the benzotriazole derivative containing a hydroxyl group include, for instance, 2-(2′-hydroxy-5′-methylphenyl)benzotriazole, 2-(2′-hydroxy-5′-t-butylphenyl)benzotriazole, 2-(2′-hydroxy-3′,5′-di-t-butylphenyl)benzotriazole, 2-(2′-hydroxy-3′-t-butyl-5′-methylphenyl)-5-chlorobenzotriazole, 2-(2′-hydroxy-3′,5′-di-t-butylphenyl)-5-chlorobenzotriazole), 2-(2′-hydroxy-3′,5′-di-t-amylphenyl)benzotriazole, 2-{2′-hydroxy-3′-(3″,4″,5″,6″-tetrahydrophthalimidomethyl)-5′-methyl phenyl}benzotriazole, 2,2-methylenebis {4-(1,1,3,3-tetramethylbutyl)-6-(2H-benzotriazol-2-yl) phenol}, 2-(2′-hydroxy-4′-octylphenyl)benzotriazole, 2-(2,4-dihydroxyphenyl)-2H-benzotriazole, 2-(2,4-dihydroxyphenyl)-5-chloro-2H-benzotriazole, 2-[2′-hydroxy-5′(2-hydroxyethyl)phenyl]-2H-benzotriazole, 2-[2′-hydroxy-5′-(3-hydroxypropyl)phenyl]-2H-benzotriazole, 242H-benzotriazol-2-yl)-4-(1-hydroxyethyl)phenol, 2-(2H-(benzotriazol-2-yl)-4-(1-hydroxy-1-methylethyl)phenol, 2-(2-hydroxyphenyl)-2H-benzotriazole-5-ol, 2-(2,4-dihydroxyphenyl)-2H-benzotriazole-5-ol, 2-(2,4,6-trihydroxyphenyl)-2H-benzotriazole-5-ol, or 2-(2,4,6-trihydroxyphenyl)-1,3-bis-(2H-benzotriazole).

Solvent (C)

The solvent used in the liquid crystal alignment agent of the invention is not particularly limited, and only needs to be able to dissolve the polymer (A) and any other components without reacting therewith. The solvent is preferably the same as the solvent used in the synthesis of the polyamic acid, and at the same time, the poor solvent used in the synthesis of the polyamic acid can also be used together.

Specific examples of the solvent (C) include, but are not limited to, for instance, N-methyl-2-pyrrolidone (NMP), γ-butyrolactone, γ-butyrolactam, 4-hydroxy-4-methyl-2-pentanone, ethylene glycol monomethyl ether, butyl lactate, butyl acetate, methyl methoxypropionate, ethyl ethoxypropionate, ethylene glycol monomethyl ether, ethylene glycol monoethyl ether, ethylene glycol n-propyl ether, ethylene glycol isopropyl ether, ethylene glycol n-butyl ether, ethylene glycol dimethyl ether, ethylene glycol ethyl ether acetate, diethylene glycol dimethyl ether, diethylene glycol diethyl ether, diethylene glycol monomethyl ether, diethylene glycol monoethyl ether, diethylene glycol monomethyl ether acetate, diethylene glycol monoethyl ether acetate, N,N-dimethyl formamide, or N,N-dimethyl acetamide. The solvent (C) can be used alone or in multiple combinations.

Based on a usage amount of 100 parts by weight of the polymer (A), the usage amount of the solvent (C) is 500 parts by weight to 5000 parts by weight, preferably 900 parts by weight to 3500 parts by weight, and more preferably 1000 parts by weight to 3000 parts by weight.

Additive (D)

Without affecting the efficacy of the invention, an additive (D) can further optionally be added to the liquid crystal alignment agent, wherein the additive (D) includes a compound having at least two epoxy groups, a silane compound having a functional group, or a combination thereof.

The compound having at least two epoxy groups includes, but is not limited to, ethylene glycol diglycidyl ether, polyethylene glycol diglycidyl ether, propylene glycol diglycidyl ether, tripropylene glycol diglycidyl ether, polypropylene glycol diglycidyl ether, neopentyl glycol diglycidyl ether, 1,6-hexanediol diglycidyl ether, glycerol diglycidyl ether, 2,2-dibromo-neopentyl glycol diglycidyl ether, 1,3,5,6-tetraglycidyl-2,4-hexanediol, N,N,N′,N′-tetraglycidyl-m-xylenediamine, 1,3-bis(N,N-diglycidylaminomethyl)cyclohexane, N,N,N′,N′-tetraglycidyl-4,4′-diaminodiphenyl methane, 3-(N,N-diglycidyl)aminopropyltrimethoxysilane, or a combination of the compounds.

The compound having at least two epoxy groups can be used alone or in multiple combinations.

Based on a usage amount of 100 parts by weight of the polymer (A), the usage amount of the compound having at least two epoxy groups can be 0 parts by weight to 40 parts by weight, preferably 0.1 parts by weight to 30 parts by weight.

Specific examples of the silane compound having a functional group include, but are not limited to, 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-trimethoxysilylpropyltriethylenetriamine, 10-trimethoxysilyl-1,4,7-triazadecane, 10-triethoxysilyl-1,4,7-triazadecane, 9-trimethoxysilyl-3,6-diazanonylacetate, 9-triethoxysilyl-3,6-diazanonylacetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, N-bis(oxyethylene)-3-aminopropyl triethoxysilane, or a combination of the compounds.

The silicon compound having a functional group can be used alone or in multiple combinations.

Based on a usage amount of 100 parts by weight of the polymer (A), the usage amount of the silane compound having a functional group can be 0 parts by weight to 10 parts by weight, preferably 0.5 parts by weight to 10 parts by weight.

Based on a total usage amount of 100 parts by weight of the polymer (A), the usage amount of the additive (D) is preferably 0.5 parts by weight to 50 parts by weight, more preferably 1 part by weight to 45 parts by weight.

### <Preparation Method of Liquid Crystal Alignment Agent>

The preparation method of the liquid crystal alignment agent is not particularly limited, and a general mixing method can be used for the preparation. For instance, the polymer (A) and the benzotriazole compound (B) containing an epoxy group are first added in the solvent (C) at a temperature of 0° C. to 200° C., and the additive (D) is optionally added. Next, the mixture is continuously stirred by using a stirring apparatus until the mixture is dissolved. Moreover, the solvent (C) is preferably added under a temperature of 20° C. to 60° C.

### <Preparation Method of Liquid Crystal Alignment Film>

The liquid crystal alignment film of the invention can be formed by the above liquid crystal alignment agent.

Specifically, the preparation method of the liquid crystal alignment film can include, for instance: coating the liquid crystal alignment agent on the surface of a substrate with a method such as a roll coating method, a spin coating method, a printing method, or an ink-jet method to form a pre-coat layer. Then, a pre-bake treatment, a post-bake treatment, and an alignment treatment are performed on the pre-coat layer to obtain a substrate on which a liquid crystal alignment film is formed.

The purpose of the pre-bake treatment is to volatilize the organic solvent in the pre-coat layer. The operating temperature of the pre-bake treatment is preferably 30° C. to 120° C., more preferably 40° C. to 110° C., and even more preferably 50° C. to 100° C.

The alignment treatment is not particularly limited, and can include wrapping a cloth made from a fiber such as nylon, rayon, or cotton on a roller and performing alignment by rubbing in a certain direction.

The purpose of the post-bake treatment is to further perform a cyclodehydration (imidization) reaction on the polymer in the pre-coat layer. The operating temperature of the post-bake treatment is preferably 150° C. to 300° C., more preferably 180° C. to 280° C., and even more preferably 200° C. to 250° C.

### <Liquid Crystal Display Element and Preparation Method Thereof>

The liquid crystal display element of the invention includes the liquid crystal alignment film formed by the liquid crystal alignment agent of the invention. The liquid crystal display element of the invention can be manufactured according to the following method.

Two substrates on which a liquid crystal alignment film is formed are prepared, and a liquid crystal is disposed between the two substrates to make a liquid crystal cell. To make the liquid crystal cell, the following two methods can be provided.

The first method includes first disposing the two substrates opposite to each other with a gap (cell gap) in between such that each liquid crystal alignment film is opposite to one another. Then, the peripheries of the two substrates are laminated together with a sealant. Next, liquid crystal is injected into the cell gap divided by the surfaces of the substrates and the sealant, and then the injection hole is sealed to obtain the liquid crystal cell.

The second method is called ODF (one drop fill, instillation). First, an ultraviolet curable sealing material for instance is coated on a predetermined portion on one of the two substrates on which the liquid crystal alignment films are formed. Then, liquid crystal is dropped onto the liquid crystal alignment film, and then the other substrate is bonded such that the liquid crystal alignment films are opposite to each other. Next, ultraviolet is irradiated on the entire substrate surface such that the sealant is cured. The liquid crystal cell can thus be made.

When any one of the above methods is used, preferably, after the liquid crystal cell is next heated to the temperature at which the liquid crystal used is in an isotropic phase, the liquid crystal cell is slowly cooled to room temperature to remove flow alignment when the liquid crystal is filled.

Next, by laminating a polarizer on the outer surface of the liquid crystal cell, the liquid crystal display element of the invention can be obtained.

The sealant includes, for instance, an epoxy resin containing an alumina ball used as a spacer or a curing agent.

The polarizer used on the outside of the liquid crystal cell can include, for instance, a polarizer formed by a polarizing film known as “H film” obtained when iodine is absorbed at the same time that polyvinyl alcohol is stretch aligned by clamping with a cellulose acetate protective film, or a polarizer formed by the “H film” itself.

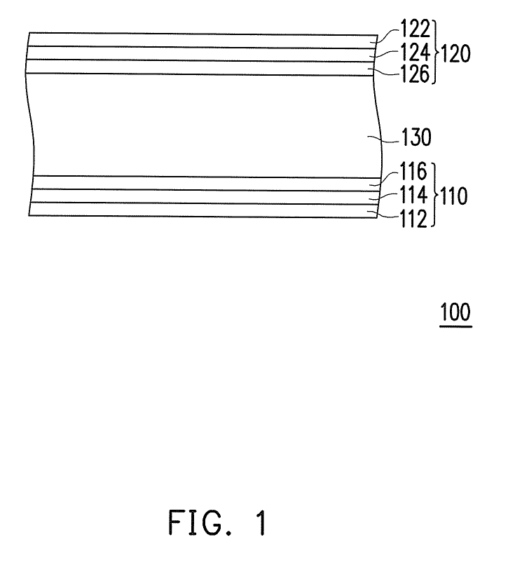

FIG. 1 is a side view of a liquid crystal display element according to an embodiment of the invention. A liquid crystal display element 100 includes a first unit 110, a second unit 120, and a liquid crystal unit 130, wherein the second unit 120 and the first unit 110 are separately disposed and the liquid crystal unit 130 is disposed between the first unit 110 and the second unit 120.

The first unit 110 includes a first substrate 112, a first conductive film 114, and a first liquid crystal alignment film 116, wherein the first conductive film 114 is formed on the surface of the first substrate 112. Moreover, the first conductive film 114 is located between the first substrate 112 and the first liquid crystal alignment film 116, and the first liquid crystal alignment film 116 is located at one side of the liquid crystal unit 130.

The second unit 120 includes a second substrate 122, a second conductive film 124, and a second liquid crystal alignment film 126, wherein the second conductive film 124 is formed on the surface of the second substrate 122. Moreover, the second conductive film 124 is located between the second substrate 122 and the second liquid crystal alignment film 126, and the second liquid crystal alignment film 126 is located at another side of the liquid crystal unit 130. In other words, the liquid crystal unit 130 is located between the first liquid crystal alignment film 116 and the second liquid crystal alignment film 126.

The first substrate 112 and the second substrate 122 are selected from, for instance, a transparent material, wherein the transparent material includes, but is not limited to, for instance, alkali-free glass, soda-lime glass, hard glass (Pyrex glass), quartz glass, polyethylene terephthalate, polybutylene terephthalate, polyethersulfone, or polycarbonate for a liquid crystal display apparatus.

The material of each of the first conductive film 114 and the second conductive film 124 is selected from, for instance, tin oxide (SnO₂) or indium oxide-tin oxide (In₂O₃—SnO₂).

The first liquid crystal alignment film 116 and the second liquid crystal alignment film 126 are respectively the above liquid crystal alignment films, and the function thereof is to make the liquid crystal unit 130 form a pretilt angle. Moreover, when a voltage is applied to the first conductive film 114 and the second conductive film 124, an electric field can be generated between the first conductive film 114 and the second conductive film 124. The electric field can drive the liquid crystal unit 130, thereby causing change to the arrangement of the liquid crystal molecules in the liquid crystal unit 130.

The liquid crystal used in the liquid crystal unit 130 can be used alone or as a mixture, and the liquid crystal includes, but is not limited to, for instance, a diaminobenzene-based liquid crystal, a pyridazine-based liquid crystal, a Schiff base-based liquid crystal, an azoxy-based liquid crystal, a biphenyl-based liquid crystal, a phenylcyclohexane-based liquid crystal, an ester-based liquid crystal, a terphenyl-based liquid crystal, a biphenylcyclohexane-based liquid crystal, a pyrimidine-based liquid crystal, a dioxane-based liquid crystal, a bicyclooctane-based liquid crystal, or a cubane-based liquid crystal. Moreover, a cholesterol-type liquid crystal such as cholesteryl chloride, cholesteryl nonanoate, or cholesteryl carbonate, a chiral agent such as C-15 or CB-15 (made by Merck & Co.), or a ferroelectric-based liquid crystal such as p-decyloxybenzylidene-p-amino-2-methylbutyl cinnamate can further be added as needed.

The liquid crystal display element of the invention thus made has excellent display performance, and even in a high-temperature and high-humidity environment, the display performance is not worsened.

### SYNTHESIS EXAMPLES OF POLYMER (A)

In the following, synthesis example A-1-1 to synthesis example A-1-4 of the polymer (A) are described:

### Synthesis Example A-1-1

A nitrogen inlet, a stirrer, a condenser tube, and a thermometer were provided to a four-necked flask having a volume of 500 mL, and then nitrogen gas was introduced. Then, in the four-necked flask, 1.08 g (0.01 moles) of p-diaminobenzene (hereinafter a2-1), 7.93 g (0.04 moles) of 4,4′-diaminodiphenylmethane (hereinafter a2-2), and 80 g of N-methyl-2-pyrrolidone (hereinafter NMP) were added, and the components were stirred under room temperature until dissolved. Next, 10.9 g (0.05 moles) of pyromellitic dianhydride (hereinafter a1-1) and 20 g of NMP were added, and the mixture was reacted at room temperature for 2 hours. After the reaction was complete, the reaction solution was poured into 1500 ml of water to precipitate a polymer. Then, the obtained polymer was filtered and was repeatedly washed with methanol and filtered three times. The polymer was then placed in a vacuum oven and dried at a temperature of 60° C., thereby obtaining a polymer (A-1-1).

### Synthesis Example A-1-2 to Synthesis Example A-1-4

Polymer (A-1-2) to polymer (A-1-4) of synthesis example A-1-2 to synthesis example A-1-4 were respectively prepared with the same steps as synthesis example A-1-1, and the difference thereof is: the types and the usage amounts of the monomers were changed (as shown in Table 1).

In the following, synthesis example A-2-1 to synthesis example A-2-10 of the polymer (A) are described:

### Synthesis Example A-2-1

A nitrogen inlet, a stirrer, a condenser tube, and a thermometer were provided to a four-necked flask having a volume of 500 mL, and then nitrogen gas was introduced. Then, in the four-necked flask, 1.08 g (0.01 moles) of p-diaminobenzene (hereinafter a2-1), 7.93 g (0.04 moles) of 4,4′-diaminodiphenylmethane (hereinafter a2-2), and 80 g of NMP were added, and the components were stirred under room temperature until dissolved. Next, 10.9 g (0.05 moles) of pyromellitic dianhydride (hereinafter a1-1) and 20 g of NMP were added. After the mixture was reacted at room temperature for 6 hours, 97 g of NMP, 2.55 g of acetic anhydride, and 19.75 g of pyridine were added. Then, the temperature was raised to 60° C., and the mixture was continuously stirred for 2 hours to perform an imidization reaction. After the reaction was complete, the reaction solution was poured into 1500 ml of water to precipitate a polymer. Then, the obtained polymer was filtered and was repeatedly washed with methanol and filtered three times. The polymer was then placed in a vacuum oven and dried at a temperature of 60° C., thereby obtaining a polymer (A-2-1).

### Synthesis Example A-2-2 to Synthesis Example A-2-10

Polymer (A-2-2) to polymer (A-2-10) of synthesis example A-2-2 to synthesis example A-2-10 were respectively prepared with the same steps as synthesis example A-2-1, and the difference thereof is: the types and the usage amounts of the monomers were changed (as shown in Table 1).

The compounds corresponding to the labels in Table 1 are as shown below.

| Abbreviation | Component |
|---|---|
| a1-1 | Pyromellitic dianhydride |
| a1-2 | 1,2,3,4-cyclobutane tetracarboxylic dianhydride |
| a1-3 | 2,3,5-tricarboxylic cyclopentyl acetic dianhydride |
| a1-4 | 3,4-dicarboxy-1,2,3,4-tetrahydronaphthalene-1-succinic dianhydride |
| a2-1 | p-diaminobezene |
| a2-2 | 4,4′-diaminodiphenyl methane |
| a2-3 | 4,4′-diaminodiphenyl ether |
| a2-4 | 4,4′-diaminodicyclohexyl methane |
| a2-5 | 1-octadecoxy-2,4-diaminobenzene |
| a2-6 | 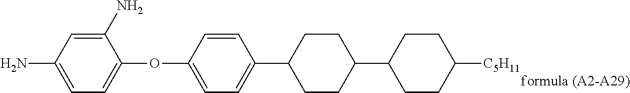 |
| a2-7 | 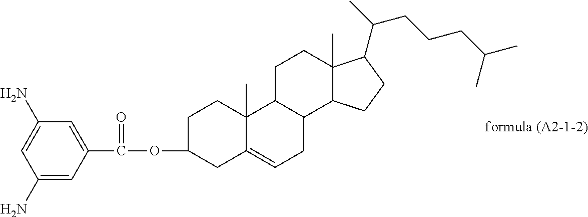 [SMILES: CC(C)CCCC(C)C1CCC2C3CC=C4CC(OC(=O)c5cc(N)cc(N)c5)CCC4(C)C3CCC12C] |

TABLE 1

| Component | | Synthesis example | | | | | | | | | | | | | |
|---|---|---|---|---|---|---|---|---|---|---|---|---|---|---|---|
| (unit: mole %) | | A-1-1 | A-1-2 | A-1-3 | A-1-4 | A-2-1 | A-2-2 | A-2-3 | A-2-4 | A-2-5 | A-2-6 | A-2-7 | A-2-8 | A-2-9 | A-2-10 |
| Tetracarboxylic | a1-1 | 100 | | | | 100 | | | | 80 | | | 95 | | |
| dianhydride | a1-2 | | 100 | | | | 100 | | | 20 | | 100 | | 70 | |
| component (a1) | a1-3 | | | 50 | 100 | | | 50 | 100 | | | | | | 100 |
| | a1-4 | | | 50 | | | | 50 | | | 100 | | | 30 | |
| Diamine | a2-1 | 20 | | 100 | 50 | 20 | | 100 | | | 10 | | 70 | | 90 |
| component (a2) | a2-2 | 80 | | | | 80 | | | 90 | 100 | 10 | | 30 | | |
| | a2-3 | | 95 | | | | 95 | | | | | 90 | | | |
| | a2-4 | | | | | | | | 10 | | 80 | 2 | | 85 | 15 |
| | a2-5 | | 5 | | | | 5 | | | | | | | | |
| | a2-6 | | | | | | | | | | | | | 5 | |
| | a2-7 | | | | 50 | | | | | | | 8 | | 10 | |

| | | | | | | | | | | | | | | |
|---|---|---|---|---|---|---|---|---|---|---|---|---|---|---|
| Imidization ratio (%) | 0 | 0 | 0 | 0 | 12 | 23 | 30 | 42 | 50 | 64 | 78 | 86 | 90 | 95 |

### SYNTHESIS EXAMPLES OF THE BENZOTRIAZOLE COMPOUND (B) CONTAINING AN EPOXY GROUP

Synthesis example B-1 to synthesis example B-6 of the benzotriazole compound (B) containing an epoxy group are described below:

### Synthesis Example B-1

### Compound (B-3-4)

A nitrogen inlet, a stirrer, a condenser tube, and a thermometer were provided to a three-necked flask having a volume of 500 mL, and then nitrogen gas was introduced. Then, in the three-necked flask, 51.0 g (0.2 moles) of 3-(2H-benzotriazole-2-yl)-4-hydroxyphenethyl alcohol and 150 mL of methyl ethyl ketone were added. Then, after 18.5 g (0.2 moles) of epichlorohydrin (hereinafter ECH) was added using an injector, 55.3 g (0.4 moles) of potassium carbonate was added while stirring. Then, after reacting at a temperature of 50° C. for 11 hours, the mixture was cooled to room temperature and vacuum filtration was performed, and then washing was performed with 5% aqueous solution of sodium hydroxide and 10% aqueous solution of sodium sulfate. Lastly, the organic layer was dried using magnesium sulfate, and the solvent was removed via distillation to obtain a compound (B-3-4a).

A nitrogen inlet, a stirrer, a condenser tube, an addition funnel, and a thermometer were provided to another three-necked flask having a volume of 500 mL, and then nitrogen gas was introduced. Then, in the three-necked flask, 30.2 g (0.15 moles) of 3-isopropenyl-α,α-dimethylbenzyl isocyanate (hereinafter m-TMI) and 50 mL of toluene were added. After the mixture was stirred and dissolved, the mixture was heated to 70° C., and 0.01 equivalents of dibutyl tin dilaurate was added in a stirring state. Then, after 46.6 g (0.15 moles) of the obtained compound (B-3-4a) was dissolved in 50 mL of toluene, the mixture was added to the addition funnel in a nitrogen environment, and then the mixture was added dropwise to the three-necked flask within 30 minutes. Then, after reacting at 70° C. for 3 hours, the mixture was cooled to room temperature and washed with distilled water three times, and then the organic layer was dried using magnesium sulfate. Then, the solvent was removed via distillation to obtain a benzotriazole compound (B-3-4) containing an epoxy group.

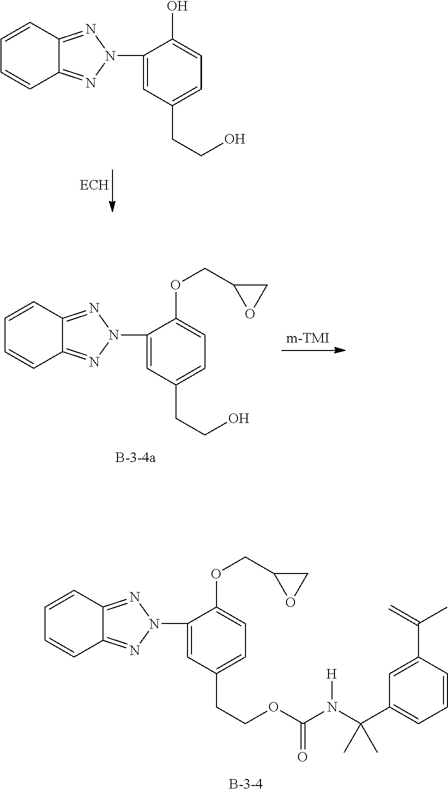 [SMILES: OCCc1ccc(O)c(-n2nc3ccccc3n2)c1 ; OCCc1ccc(OCC2CO2)c(-n2nc3ccccc3n2)c1 ; C=C(C)c1cccc(C(C)(C)NC(=O)OCCc2ccc(OCC3CO3)c(-n3nc4ccccc4n3)c2)c1]

### Synthesis Example B-2

### Compound (B-3-5)

A nitrogen inlet, a stirrer, an addition funnel, and a thermometer were provided to a three-necked flask having a volume of 500 mL, and then nitrogen gas was introduced. Then, in the three-necked flask, 57.54 g (0.185 moles) of the compound (B-3-4a) obtained in synthesis example B-1, 150 mL of acetone, and 150 mL of triethylamine were added, and the mixture was stirred until dissolved and then cooled to 0° C. Then, after 20.16 g (0.24 moles) of diketene was dissolved in 20 mL of acetone, the mixture was added to the addition funnel in a nitrogen environment, and then the mixture was added dropwise to the three-necked flask within 30 minutes. Then, after reacting at room temperature for 5 hours, distillation under reduced pressure was performed to remove the solvent. Lastly, after the resulting product was washed with water and hexane in order, drying was performed to obtain a benzotriazole compound (B-3-5) containing an epoxy group.

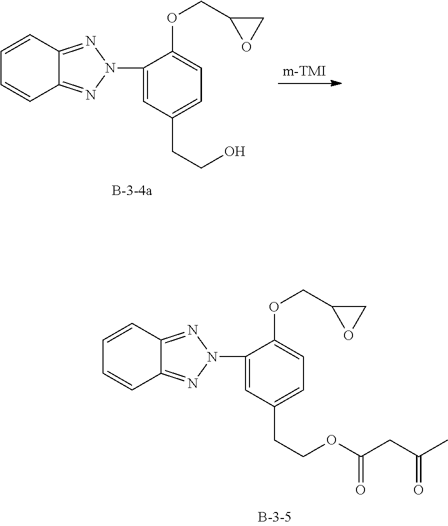 [SMILES: OCCc1ccc(OCC2CO2)c(-n2nc3ccccc3n2)c1 ; CC(=O)CC(=O)OCCc1ccc(OCC2CO2)c(-n2nc3ccccc3n2)c1]

### Synthesis Example B-3

### Compound (B-3-9)

A nitrogen inlet, a stirrer, a condenser tube, and a thermometer were provided to a three-necked flask having a volume of 500 mL, and then nitrogen gas was introduced. Then, in the three-necked flask, 6.21 g (0.05 moles) of 1,2-epoxy-4-vinyl cyclohexane, 6.70 g (0.05 moles) of 1,1,3,3-tetramethyldisiloxane, and 10 mL of toluene were added, and the mixture was stirred until dissolved. Then, 8 mg of tris(triphenyl phosphine)rhodium(I)chloride was added, and the mixture was heated to 85° C. to react for 6 hours. After the reaction was complete, the mixture was cooled to room temperature and vacuum filtration was performed to obtain a compound (B-3-9a).

A nitrogen inlet, a stirrer, a condenser tube, and a thermometer were provided to another three-necked flask having a volume of 500 mL, and then nitrogen gas was introduced. Then, in the three-necked flask, 14.75 g (0.05 moles) of 3-(2H-benzotriazole-2-yl)-4-hydroxyphenethyl allyl ether and 10 mL of toluene were added, and the mixture was stirred until dissolved. Then, 12.90 g (0.05 moles) of the compound (B-3-9a) obtained above was added, and after heating to 60° C., one drop of Karstedt's catalyst was added. Then, after reacting at a temperature of 60° C. for 3 hours, the mixture was cooled to room temperature and methanol was poured into the mixture for precipitation, and then after washing and filtering with methanol three times, the mixture was placed in a vacuum oven. After drying was performed at 60° C. for 8 hours, a benzotriazole compound (B-3-9) containing an epoxy group was obtained.

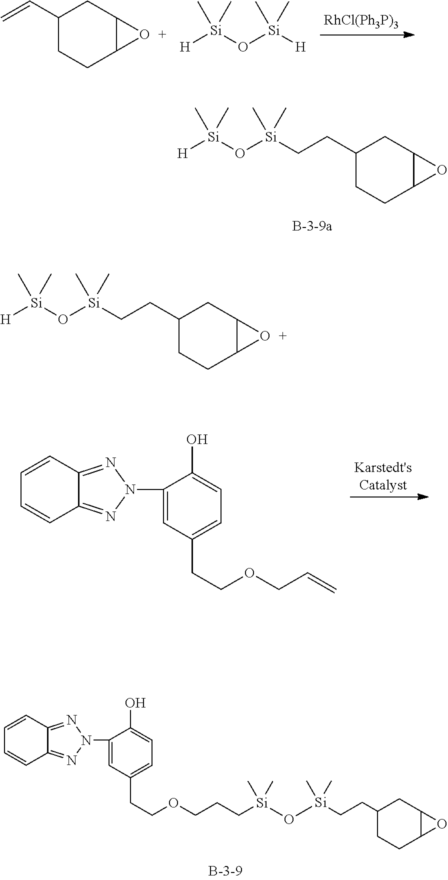

### Synthesis Example B-4

### Compound (B-3-11)

A nitrogen inlet, a stirrer, and a thermometer were provided to a three-necked flask having a volume of 5 L, and then nitrogen gas was introduced. Then, in the three-necked flask, 255 g (1.0 mole) of 4-(2H-benzotriazole-2-yl)-3-hydroxyphenethyl alcohol, 200 g (2.0 moles) of succinic anhydride, 15 g of N,N-dimethylamino pyridine, 180 mL of triethylamine, and 2 L of ethyl acetate were added, and after reacting at 90° C. for 8 hours, ethyl acetate was removed via distillation under reduced pressure. Then, 2 L of trichloromethane was added, and after the organic layer was washed with diluted hydrochloric acid and water in order 4 times, drying was performed with magnesium sulfate. Then, a rotary concentrator (made by EYELA; model: N-1000) was used for processing for 1 hour, and then methanol was poured into the mixture to perform precipitation. Lastly, after the precipitate was filtered, the solvent was removed via distillation to obtain a compound (B-3-11a).

A nitrogen inlet, a stirrer, and a thermometer were provided to another three-necked flask having a volume of 5 L, and then nitrogen gas was introduced. Then, in the three-necked flask, 35.5 g (0.1 moles) of the compound (B-3-11a) obtained above, 7.4 g (0.1 moles) of glycidol, and 500 mL of tetrahydrofuran were added, and the mixture was stirred at 0° C. until dissolved. Then, 25 g of N,N-dicyclohexyl carbodiimide and 2.4 g of N,N-dimethylaminopyridine were added, and after the mixture was stirred at room temperature for 4 hours, 2 L of trichloromethane was added, and after the mixture was washed with diluted hydrochloric acid and water in order 4 times, drying was performed with magnesium sulfate and the solvent was removed via distillation to obtain a benzotriazole compound (B-3-11) containing an epoxy group.

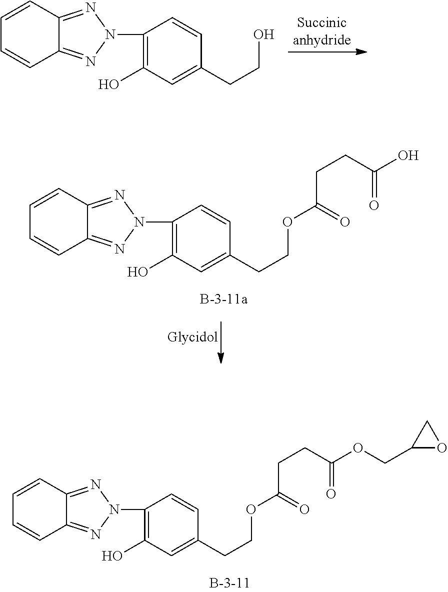 [SMILES: OCCc1ccc(-n2nc3ccccc3n2)c(O)c1 ; O=C(O)CCC(=O)OCCc1ccc(-n2nc3ccccc3n2)c(O)c1 ; O=C(CCC(=O)OCC1CO1)OCCc1ccc(-n2nc3ccccc3n2)c(O)c1]

### Synthesis Example B-5

### Compound (B-3-8)

A nitrogen inlet, a stirrer, a condenser tube, and a thermometer were provided to a three-necked flask having a volume of 500 mL, and then nitrogen gas was introduced. Then, in the three-necked flask, 45.4 g (0.2 moles) of 5-hydroxy-2-(hydroxy phenyl)benzotriazole and 150 mL of methyl ethyl ketone were added. Then, after 18.5 g (0.2 moles) of ECH was added using an injector, 55.3 g (0.4 moles) of potassium carbonate was added while stirring. Then, after reacting at a temperature of 50 t for 11 hours, the mixture was cooled to room temperature and vacuum filtration was performed, and then washing was performed with 5% aqueous solution of sodium hydroxide and 10% aqueous solution of sodium sulfate. Lastly, the organic layer was dried using magnesium sulfate, and the solvent was removed via distillation to obtain a compound (B-3-8).

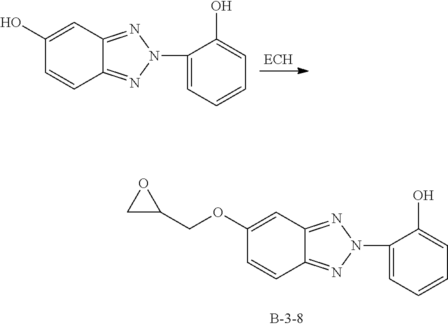 [SMILES: Oc1ccc2nn(-c3ccccc3O)nc2c1 ; Oc1ccccc1-n1nc2ccc(OCC3CO3)cc2n1]

### Synthesis Example B-6

### Compound (B-4-1)

A nitrogen inlet, a stirrer, a condenser tube, and a thermometer were provided to a three-necked flask having a volume of 500 mL, and then nitrogen gas was introduced. Then, in the three-necked flask, 72.0 g (0.2 moles) of 2-(2,4,6-trihydroxyphenyl)-1,3-di-(2H-benzotriazole) and 150 mL of methyl ethyl ketone were added. Then, after 18.5 g (0.2 moles) of ECH was added using an injector, 55.3 g (0.4 moles) of potassium carbonate was added while stirring. Then, after reacting at a temperature of 50° C. for 11 hours, the mixture was cooled to room temperature and vacuum filtration was performed, and then washing was performed with 5% aqueous solution of sodium hydroxide and 10% aqueous solution of sodium sulfate. Lastly, the organic layer was dried using magnesium sulfate, and the solvent was removed via distillation to obtain a compound (B-4-1).

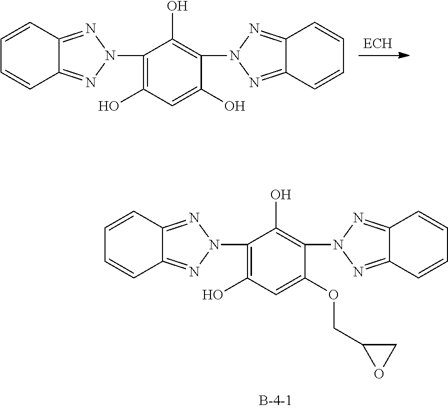 [SMILES: Oc1cc(O)c(-n2nc3ccccc3n2)c(O)c1-n1nc2ccccc2n1 ; Oc1cc(OCC2CO2)c(-n2nc3ccccc3n2)c(O)c1-n1nc2ccccc2n1]

Examples and comparative examples of liquid crystal alignment agent, liquid crystal alignment film, and liquid crystal display element

Example 1 to example 13 and comparative example 1 to comparative example 6 of the liquid crystal alignment agent, the liquid crystal alignment film, and the liquid crystal display element are described below:

a. Liquid Crystal Alignment Agent

100 parts by weight of the polymer (A-1-1), 3 parts by weight of the benzotriazole compound (B-1) containing an epoxy group, 800 parts by weight of N-methyl-2-pyrrolidone (C-1 hereinafter), and 800 parts by weight of ethylene glycol n-butyl ether (C-2 hereinafter) were weighed. Then, the components were stirred and mixed at room temperature to form the liquid crystal alignment agent of example 1.

b. Liquid Crystal Alignment Film and Liquid Crystal Display Element

The above liquid crystal alignment agent was respectively coated on two glass substrates having a conductive film formed by indium-tin-oxide (ITO) by a printing press (made by Nissha Printing Co., Ltd., model: S 15-036) to form a pre-coat layer. Then, the glass substrates were placed on a heating plate and pre-bake was performed at a temperature of 100° C. and a time of 5 minutes. Next, post-bake was performed in a circulation oven at a temperature of 220° C. and a time of 30 minutes. Lastly, after alignment treatment, glass substrates on which the liquid crystal alignment film of example 1 was formed were obtained.

A hot press sealant was coated on one of the two obtained glass substrates on which a liquid crystal alignment film was formed, and a 4 μm spacer was sprinkled on the other. Next, the two glass substrates were laminated, and a pressure of 10 kg was applied with a hot press machine to perform hot press lamination at a temperature of 150° C. Then, injection of liquid crystal was performed with a liquid crystal injection machine (made by Shimadzu Corporation, model: ALIS-100X-CH). Next, the injection port of liquid crystal was sealed with an ultraviolet curing sealant, an ultraviolet lamp was used to cure the ultraviolet curing sealant by irradiation, and a liquid crystal annealing treatment was performed in an oven at a temperature of 60° C. for 30 minutes, thereby obtaining the liquid crystal display element of example 1.

The liquid crystal display element of example 1 was evaluated by each of the following evaluation methods, and the results thereof are as shown in Table 2.

### Example 2 to Example 13

The liquid crystal alignment agents, the liquid crystal alignment films, and the liquid crystal display elements of example 2 to example 13 were respectively prepared by the same steps as example 1, and the difference thereof is: the types and the usage amounts of the components were changed, as shown in Table 2. The liquid crystal display element of each of examples 2 to 13 was evaluated with the evaluation methods below, and the results thereof are as shown in Table 2.

### Comparative Example 1 to Comparative Example 6

The liquid crystal alignment agents, the liquid crystal alignment films, and the liquid crystal display elements of comparative example 1 to comparative example 6 were respectively prepared by the same steps as example 1, and the difference is: the types and the usage amounts of the components were changed, as shown in Table 3. The liquid crystal display element obtained in each of comparative example 1 to comparative example 6 was evaluated with the evaluation methods below, and the results thereof are as shown in Table 3.

The compounds corresponding to the abbreviations in Table 2 and Table 3 are as shown below.

| Abbreviation | Component |
|---|---|
| A-1-1 | Polymer (A-1-1) |
| A-1-2 | Polymer (A-1-2) |
| A-1-3 | Polymer (A-1-3) |
| A-1-4 | Polymer (A-1-4) |
| A-2-1 | Polymer (A-2-1) |
| A-2-2 | Polymer (A-2-2) |
| A-2-3 | Polymer (A-2-3) |
| A-2-4 | Polymer (A-2-4) |
| A-2-5 | Polymer (A-2-5) |
| A-2-6 | Polymer (A-2-6) |
| A-2-7 | Polymer (A-2-7) |
| A-2-8 | Polymer (A-2-8) |
| A-2-9 | Polymer (A-2-9) |
| A-2-10 | Polymer (A-2-10) |
| B-1 | 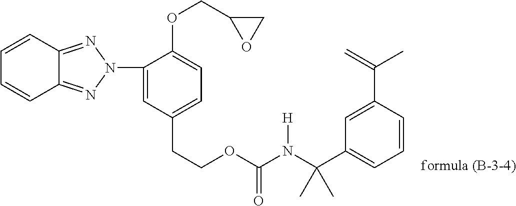 [SMILES: C=C(C)c1cccc(C(C)(C)NC(=O)OCCc2ccc(OCC3CO3)c(-n3nc4ccccc4n3)c2)c1] |
| B-2 | 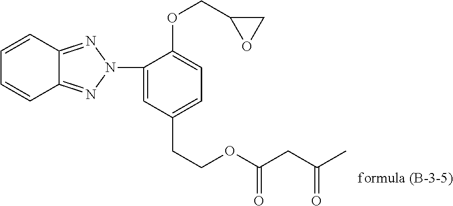 [SMILES: CC(=O)CC(=O)OCCc1ccc(OCC2CO2)c(-n2nc3ccccc3n2)c1] |
| B-3 | 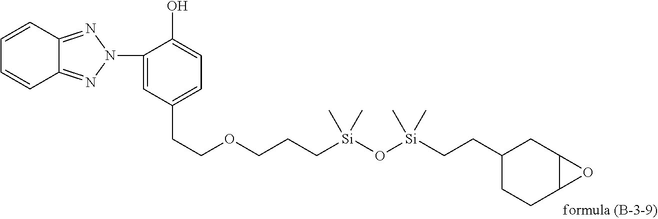 [SMILES: C[Si](C)(CCCOCCc1ccc(O)c(-n2nc3ccccc3n2)c1)O[Si](C)(C)CCC1CCC2OC2C1] |
| B-4 | 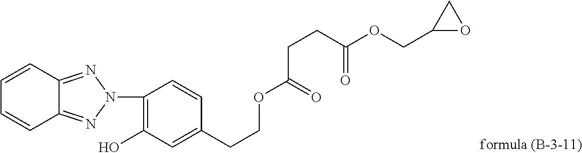 [SMILES: O=C(CCC(=O)OCC1CO1)OCCc1ccc(-n2nc3ccccc3n2)c(O)c1] |
| B-5 | 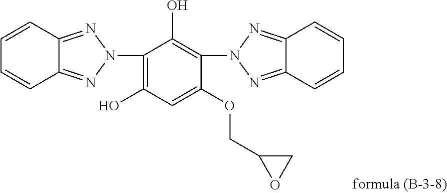 [SMILES: Oc1cc(OCC2CO2)c(-n2nc3ccccc3n2)c(O)c1-n1nc2ccccc2n1] |
| B-6 | 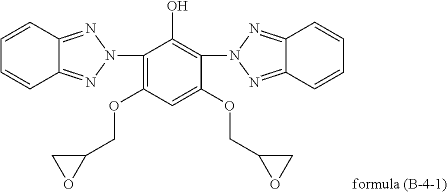 [SMILES: Oc1c(-n2nc3ccccc3n2)c(OCC2CO2)cc(OCC2CO2)c1-n1nc2ccccc2n1] |
| B′-1 | 5-methylbenzotriazole |
| B′-2 | 2-(2,4-dihydroxy phenyl)2H-benzotriazole |
| C-1 | N-methyl-2-pyrrolidone (NMP) |
| C-2 | Ethylene glycol n-butyl ether |
| C-3 | N,N-dimethylacetamide |
| C-4 | γ-butyrolactone |
| D-1 | N,N,N′,N′-tetraepoxypropyl-4,4′-diaminodiphenyl methane |
| D-2 | 3-aminopropyl triethoxysilane |

Evaluation Methods

a. Imidization Ratio

The imidization ratio refers to the proportion of the number of imide rings based on the total amount of the number of amic acid functional groups and the number of imide rings in the polymer, and is represented in percentage.

The detection method includes dissolving the polymers of the synthesis examples in a suitable deuteration solvent (for instance, deuterated dimethyl sulfoxide) after respectively performing drying under reduced pressure. Then, a result of ¹H-nuclear magnetic resonance (¹H-NMR) was detected under room temperature (such as 25° C.) and using tetramethylsilane as reference material. The imidization ratio (%) was obtained by equation (1).

$$Imidization ratio ( \% ) = 1 - \frac{Δ 1}{Δ 2 \times α} \times 100 \% \qquad equation ( 1 )$$

Δ1: peak area generated due to chemical shift of an NH group proton near 10 ppm;
Δ2: peak area of other protons;
α: number ratio of one proton of NH group relative to other protons in precursor (polyamic acid) of polymer.

b. Environmental Resistance

The liquid crystal display elements of the examples and comparative examples were respectively placed in an environment of a temperature of 65° C. and a relative humidity of 85%, and after 120 hours, the ion density of the liquid crystal display elements of example 1 to example 13 and comparative example 1 to comparative example 6 were respectively measured using an electrical measuring machine (made by Dongyang Corporation, Model 6254). The test conditions include the application of a voltage of 1.7 V and a triangle wave of 0.01 Hz at a temperature of 60° C., and the peak area was calculated in a range of 0 V to 1V in a current-voltage waveform to measure ion density (pC). A lower ion density represents better environmental resistance.

The evaluation criteria of ion density are as shown below.

⊚: ion density <20
◯: 20≦ion density <40
Δ: 40≦ion density <50
X: 50≦ion density

TABLE 2

| Component | | Example | | | | | | | | | | | | |
|---|---|---|---|---|---|---|---|---|---|---|---|---|---|---|
| (unit: parts by weight) | | 1 | 2 | 3 | 4 | 5 | 6 | 7 | 8 | 9 | 10 | 11 | 12 | 13 |
| Polymer (A) | A-1-1 | 100 | | | | | | | | | | | | 50 |
| | A-1-2 | | 100 | | | | | | | | | | | |
| | A-1-3 | | | 100 | | | | | | | | | | |
| | A-1-4 | | | | | | | | | | | | | |
| | A-2-1 | | | | 100 | | | | | | | | | |
| | A-2-2 | | | | | 100 | | | | | | | | |
| | A-2-3 | | | | | | 100 | | | | | | | |
| | A-2-4 | | | | | | | 100 | | | | | | |
| | A-2-5 | | | | | | | | 100 | | | | | |
| | A-2-6 | | | | | | | | | 100 | | | | |
| | A-2-7 | | | | | | | | | | 100 | | | |
| | A-2-8 | | | | | | | | | | | 100 | | |
| | A-2-9 | | | | | | | | | | | | 100 | |
| | A-2-10 | | | | | | | | | | | | | 50 |
| Benzotriazole | B-1 | 3 | | | | | 1 | | | | 2 | | | 10 |
| compound (B) | B-2 | | 6 | | | 5 | | | 12 | | 2 | 3 | | |
| containing an | B-3 | | | 8 | | | | | | | | 6 | 7 | |
| epoxy group | B-4 | | | | 10 | | | | | 3 | | | 7 | |
| | B-5 | | | | 5 | | | | | | | | | |
| | B-6 | | | | | | | 2 | | | | | | |
| Other | B′-1 | | | | 3 | | | | | | | | | |
| benzotriazole | B′-2 | | | | | | | | | | 2 | | | |
| compounds | | | | | | | | | | | | | | |
| (B′) | | | | | | | | | | | | | | |
| Solvent (C) | C-1 | 800 | | | 900 | | | 1000 | | 750 | 1200 | | 800 | 500 |
| | C-2 | 800 | | 500 | | 600 | | 1000 | 1500 | | | 3000 | | 400 |
| | C-3 | | 1800 | 2000 | | 50 | | 1500 | | 750 | | 1800 | 800 | |
| | C-4 | | | | 900 | | 3000 | | 800 | 400 | 2500 | | 100 | |
| Additive (D) | D-1 | | | 5 | | | | | | | | 1 | | |
| | D-2 | | | | | 3 | | | | | | 2 | | |

| | | | | | | | | | | | | | |
|---|---|---|---|---|---|---|---|---|---|---|---|---|---|
| Evaluation results of | ◯ | ⊚ | ⊚ | ⊚ | ⊚ | ⊚ | ⊚ | ⊚ | ⊚ | ⊚ | ⊚ | ⊚ | ◯ |
| environmental | | | | | | | | | | | | | |
| resistance | | | | | | | | | | | | | |

TABLE 3

| Component | | Comparative example | | | | | |
|---|---|---|---|---|---|---|---|
| (unit: parts by weight) | | 1 | 2 | 3 | 4 | 5 | 6 |
| Polymer (A) | A-1-1 | 100 | | | | | |
| | A-1-2 | | | | 100 | | |
| | A-1-3 | | | | | | |
| | A-1-4 | | | | | | 100 |
| | A-2-1 | | 100 | | | | |
| | A-2-2 | | | | | 100 | |
| | A-2-3 | | | | | | |
| | A-2-4 | | | | | | |
| | A-2-5 | | | | | | |
| | A-2-6 | | | 100 | | | |
| | A-2-7 | | | | | | |
| | A-2-8 | | | | | | |
| | A-2-9 | | | | | | |
| | A-2-10 | | | | | | |
| Benzotriazole | B-1 | | | | | | |
| compound (B) | B-2 | | | | | | |
| containing an epoxy | B-3 | | | | | | |
| group | B-4 | | | | | | |
| | B-5 | | | | | | |
| | B-6 | | | | | | |
| Other benzotriazole | B′-1 | | | | 6 | | |
| compounds (B′) | B′-2 | | | | | 5 | |
| Solvent (C) | C-1 | 800 | 900 | 750 | | | 3400 |
| | C-2 | 800 | | | | 600 | |
| | C-3 | | | 750 | 1800 | 50 | |
| | C-4 | | 900 | 400 | | | |
| Additive (D) | D-1 | | | | | | 5 |
| | D-2 | | | | | 3 | |

| | | | | | | |
|---|---|---|---|---|---|---|
| Evaluation results of | X | X | X | X | X | X |
| environmental resistance | | | | | | |

### <Evaluation Results>

It can be known from Table 2 and Table 3 that, in comparison to the liquid crystal alignment films (example 1 to example 13) formed by the liquid crystal alignment agent using the benzotriazole compound (B) containing an epoxy group, the environmental resistance of the liquid crystal alignment films (comparative examples 1 to 3 and 6) formed by the liquid crystal alignment agent without the benzotriazole compound (B) containing an epoxy group is poor; and the environmental resistance of the liquid crystal alignment films (comparative examples 4 and 5) formed by the liquid crystal alignment agent using the benzotriazole compound (B′) without an epoxy group is also poor.

Moreover, when the imidization ratio of the polymer (A) in the liquid crystal alignment agent is 30% to 90%, the environmental resistance of the formed liquid crystal alignment films (examples 6 to 12) is particularly good.

Moreover, when the polymer (A) in the liquid crystal alignment agent contains the diamine compounds (a2) represented by formula (A2-1), formula (A2-2), and formula (A2-26) to formula (A2-30), the environmental resistance of the formed liquid crystal alignment films (examples 2, 5, 10, and 12) is particularly good.

Moreover, when the benzotriazole compound (B) containing an epoxy group in the liquid crystal alignment agent contains at least one hydroxyl group, the environmental resistance of the formed liquid crystal alignment films (examples 3, 4, 7, 9, 11, and 12) is particularly good.

Based on the above, since the liquid crystal alignment agent of the invention contains the benzotriazole compound (B) containing an epoxy group, when the liquid crystal alignment agent is applied in a liquid crystal alignment film, the liquid crystal alignment film has better environmental resistance, and therefore the liquid crystal alignment film is suitable for a liquid crystal display element.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A liquid crystal alignment agent, comprising:
a polymer (A), wherein the polymer (A) is obtained by reacting a mixture comprising a tetracarboxylic dianhydride component (a1) and a diamine component (a2);
a benzotriazole compound (B) containing an epoxy group; and
a solvent (C).

2. The liquid crystal alignment agent of claim 1, wherein the epoxy group of the benzotriazole compound (B) containing an epoxy group is selected from at least one of the group consisting of functional groups represented by general formula (B-1) and general formula (B-2); 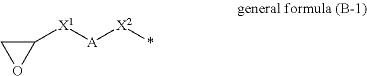
in general formula (B-1), A represents a single bond, an ether group, an ester group, or a urethane group; X¹ represents a C₁ to C₅ alkylene group; X² represents a single bond or a C₁ to C₆ alkylene group; and * represents a bonding site; 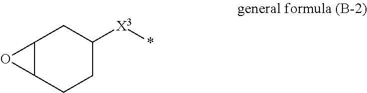
in general formula (B-2), X³ represents a single bond or a C₁ to C₆ alkylene group; and * represents a bonding site.

3. The liquid crystal alignment agent of claim 1, wherein the benzotriazole compound (B) containing an epoxy group contains at least one hydroxyl group.

4. The liquid crystal alignment agent of claim 1, wherein based on a total amount of 100 parts by weight of the polymer (A), a usage amount of the benzotriazole compound (B) containing an epoxy group is 1 part by weight to 15 parts by weight.

5. The liquid crystal alignment agent of claim 1, wherein an imidization ratio of the polymer (A) is 30% to 90%.

6. A liquid crystal alignment film formed by the liquid crystal alignment agent of claim 1.

7. A liquid crystal display element, comprising the liquid crystal alignment film of claim 6.
